(19) United States
(12) Patent Application Publication
(10) Pub. No.: US 2014/0187321 A1
(43) Pub. Date: Jul. 3, 2014

(54) GAME MACHINE

(71) Applicant: Kyoraku Industrial Co., Ltd., Nagoya-shi (JP)

(72) Inventors: Ryo MORIMOTO, Nagoya-shi (JP); Yukinaga Yasuda, Nagoya-shi (JP); Yasutake Suzuki, Nagoya-shi (JP); Yuji Isogimi, Nagoya-shi (JP); Masayuki Taniguchi, Nagoya-shi (JP); Yasunori Higuchi, Nagoya-shi (JP); Tomoshige Kawai, Nagoya-shi (JP); Tatsuya Nakamura, Nagoya-shi (JP); Mitsuhiro Kanemoto, Nagoya-shi (JP); Satoshi Manabe, Nagoya-shi (JP)

(73) Assignee: Kyoraku Industrial Co., Ltd., Nagoya-shi (JP)

(21) Appl. No.: 14/091,624

(22) Filed: Nov. 27, 2013

(30) Foreign Application Priority Data
Dec. 28, 2012 (JP) 2012-287676

(51) Int. Cl. A63F 13/00

(52) U.S. Cl. CPC A63F 13/00
USPC 463/31

(57) ABSTRACT

A game machine includes an operation device configured to be operated by a player. The operation device includes: a translucent operation part; a light source board on which a light source is arranged to light up the operation part from an inside of the operation part, the light source board being provided in the operation part; a detection part configured to detect an operation being accepted by the operation part; and a transmission part configured to inform the detection part of that the operation has been accepted.

### CROSS-REFERENCES TO RELATED APPLICATIONS

This application claims the benefit of Japanese Patent Application No. 2012-287676, filed Dec. 28, 2012, which is incorporated herein by reference.

### BACKGROUND

1. Technical Field

The present invention relates to a game machine.

2. Related Art

Conventionally, there has been known a game machine including a light source (LED), as a lighting mechanism to light up a start lever of a slot machine, which is provided in a shaft (hollow shaft) extending from a knob (also called “grip”). Also, there has been known a game machine including a light source provided on the free end of a hollow shaft, as disclosed in Patent Literature 1.
Patent Literature 1: Japanese Patent No. 4577741

However, with the above-described conventional game machines, when a light source is provided in the hollow shaft, it is not possible to provide a plurality of light sources because of the limitation of the size of the inside diameter of the hollow shaft. Moreover, when the light source is provided on a free end of the hollow shaft, the light of the light source must enter the hollow shaft from the free end, and therefore the hollow shaft can only be lit evenly. Therefore, with the conventional game machines, there has been a problem with a lack of excitement and enjoyment due to little variation in lighting mode, such as lighting with one color and blinking.

### SUMMARY

In view of the above-described problem, it is therefore an object of the present invention to provide a game machine that can solve the problem with the little variation in lighting mode of an operation device such as a start lever.

To solve the above-described problem, according to a first aspect of the present invention, a game machine includes an operation device (e.g. start lever) configured to be operated by a player. The operation device includes a translucent operation part (e.g. knob); a light source board (e.g. LED board) on which a light source is arranged to light up the operation part from an inside of the operation part, the light source board being provided in the operation part; a detection part configured to detect an operation being accepted by the operation part; and a transmission part (e.g. shaft or wire) configured to inform the detection part of that the operation has been accepted.

According to a second aspect of the present invention, the operation part includes: a rear body configured to face the transmission part; and a front body configured not to face the transmission part, the rear body and the front body being coupled to one another while sandwiching the light source board therebetween.

According to a third aspect of the present invention, the front body is removably coupled to the rear body by screws.

According to a fourth aspect of the present invention, a plurality of light sources are arranged on the light source board.

According to a fifth aspect of the present invention, a translucent lens member including a multi-faceted lens is provided between the front body and the light source board.

According to a sixth aspect of the present invention, the transmission part is formed of a rod.

The game machine according to the present invention includes an operation device such as a start lever having a light source board on which light sources are arranged. By the operation device with various lighting modes, it is possible to increase player's excitement and enjoyment.

### BRIEF DESCRIPTION OF THE DRAWINGS

FIG. 1 is an exemplary front view showing a game machine;

FIG. 2 is an exemplary drawing showing the inner structure of a cabinet;

FIG. 3 is an exemplary drawing showing the rear surface of a front door;

FIG. 4 is an exemplary drawing showing a control panel of the front door;

FIG. 5 is a drawing showing an entire start lever;

FIG. 6 is an exploded perspective view showing the knob of the start lever from the front side;

FIG. 7 is an exploded perspective view showing the knob of the start lever from the rear side;

FIG. 8 is a schematic cross-sectional view showing the start lever;

FIG. 9 is a drawing explaining the inner structure of the knob of the start lever;

FIG. 10 is a drawing explaining the inner structure of the knob of the start lever;

FIG. 11A is a drawing explaining the inner structure of the knob of the start lever;

FIG. 11B is a drawing explaining the inner structure of the knob of the start lever;

FIG. 12A is an exemplary drawing showing a lighting mode of the start lever;

FIG. 12B is an exemplary drawing showing a lighting mode of the start lever;

FIG. 12C is an exemplary drawing showing a lighting mode of the start lever;

FIG. 12D is an exemplary drawing showing a lighting mode of the start lever;

FIG. 13A is part of a block diagram showing the entire game machine;

FIG. 13B is the remaining part of the block diagram showing the entire game machine;

FIG. 14 is an exemplary drawing showing a symbol arrangement table;

FIG. 15 is an exemplary drawing showing a performance determination table;

FIG. 16 is a drawing showing program start processing in a main control board;

FIG. 17 is a drawing showing main loop processing in the main control board;

FIG. 18 is a drawing showing interrupt processing in the main control board;

FIG. 19 is a drawing showing main processing in a sub-control board;

FIG. 20 is a drawing showing a main control board communication task in the sub-control board;

FIG. 21 is a drawing showing a lamp control task in the sub-control board;

FIG. 22 is a drawing showing command analysis processing in the sub-control board; and

FIG. 23 is a perspective view showing a video game device according to another embodiment.

### DESCRIPTION OF EXEMPLARY EMBODIMENTS

Now, an embodiment of the present invention will be described in detail with reference to the drawings.

<The Configuration of a Game Machine>

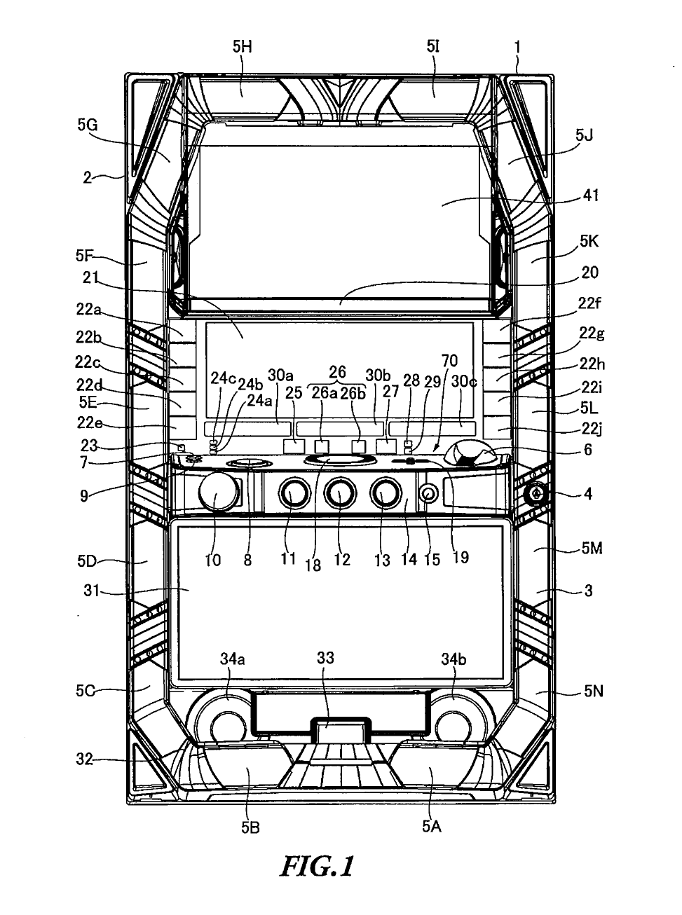

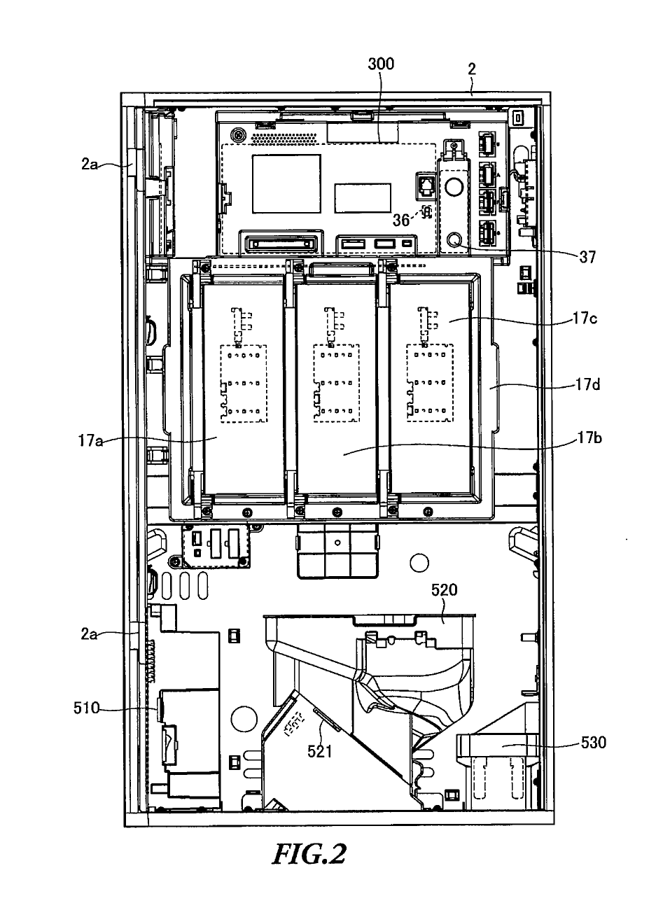

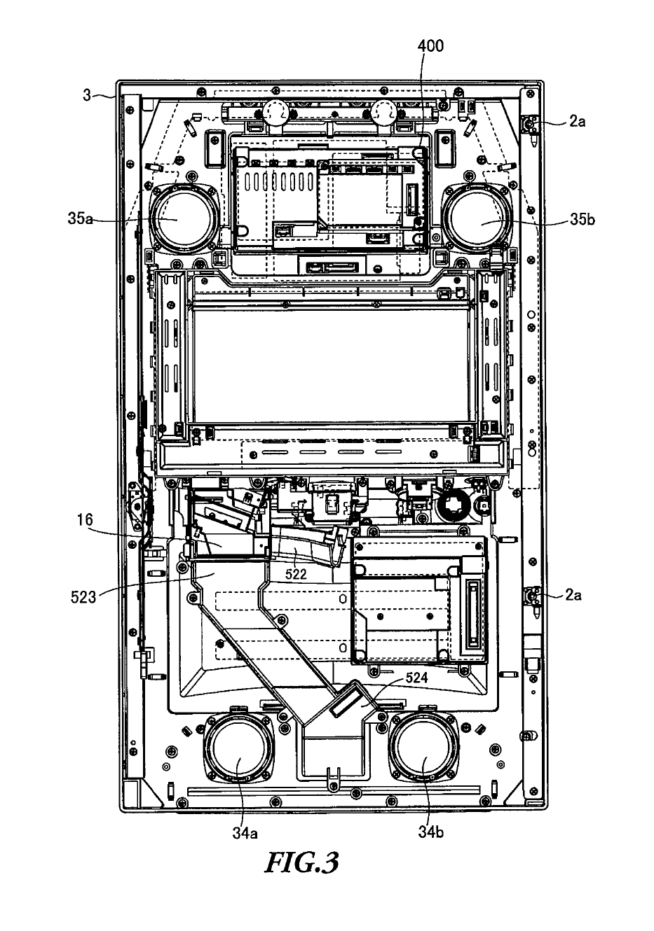

First, the configuration of a game machine 1 according to the present invention will be described in detail with reference to FIG. 1 to FIG. 3. FIG. 1 is an exemplary front view showing the game machine. FIG. 2 is an exemplary drawing showing the inner structure of a cabinet 2. FIG. 3 is an exemplary drawing showing the rear surface of a front door.

<Game Machine 1>

The game machine 1 according to the present embodiment includes the cabinet 2, the front door 3 and so forth. Here, the game machine 1 is equivalent to “game machine” recited in the appended claims. Hereinafter, “front” “back” “right” and “left” are defined as being viewed from the front side of the game machine 1.

<Cabinet 2, Hinge Mechanism 2a, and Front Door 3>

A cabinet 2 is formed of an approximately rectangular box, and has an opening in its front side. A hinge mechanism 2a provided on the front left side of the cabinet 2 pivotally supports a front door 3 to open and close the front door 3.

<Key Hole 4>

A key hole 4 is provided in the middle of the right edge of the front door 3 to lock and unlock the front door 3. Here, when a staff member of a game parlor does maintenance work or changes the setting value and so forth, the staff member unlocks and locks a lock device (not shown) provided in the front door 3. First, a dedicated key (not shown) is inserted into the key hole 4 in the front door 3 to unlock and open the front door 3, and then the maintenance work is done, and the setting value are changed. After that, when the maintenance work and the change in the setting value are finished, the dedicated key is inserted into the key hole 4 to lock the front door 3.

<Side Lamps 5A to 5N>

Side lamps 5A to 5N are provided on the right and left edges and the upper and lower edges of the front door 3, that is, provided evenly on the rim of the front door 3, and each of which includes a plurality of super bright LEDs. In addition, these side lamps 5A to 5N are designed to have shapes, colors, patterns, pictures and so forth which appeal to the player's eyes. During an ART (assist replay time) state, lighting or blinking control is performed by a sub-control board 400 during a predetermined performance or demonstration at a predetermined time, so that a performance is presented. Hereinafter, the side lamps 5A to 5N may be collectively referred to as “side lamps 5.”

<Medal Insertion Slot 6>

A medal insertion slot 6 is provided in the right side of a numerical keyboard 19 and used to insert medals by the player.

<One-Bet Button 7>

A one-bet button 7 is provided below a start lamp 23 to use one of credited medals for a game.

<Max-Bet Button 8>

A max-bet button 8 is provided on the right side of the one-bet button 7 to use the maximum number of credited medals available for one game. Here, with the present embodiment, the maximum number of medals for one game is three. Hereinafter, the one-bet button 7 and the max-bet button 8 may be collectively referred to as “bet buttons 7 and 8.”

<Adjustment Button 9>

An adjustment button 9 is provided below the start lamp 23 to adjust the credited ones of the medals acquired by the player. Here, with the present embodiment, the maximum number of creditable medals is fifty.

<Start Lever 10>

A start lever 10 is provided on the right side of the adjustment button 9 to detect a game start operation by the player. Here, based on the detection of the start operation, a random number value may be sampled by a main control board 300, and spins of a left reel 17a, a center reel 17b and a right reel 17c may be started. In addition, a knob 50 of the start lever 10 is made of translucent resin, and includes a plurality of super bright LEDs (LEDs 54A to 54G arranged on an LED board 54). Then, a sub-control board 400 controls the lighting and blinking of the plurality of LEDs 54A to 54G, based on that a predetermined condition is met. By this means, it is possible to present a performance which appeals to the player's eyes.

<Left Stop Button 11, Middle Stop Button 12, Right Stop Button 13, and Stop Button Unit 14>

A left stop button 11, a middle stop button 12 and a right stop button 13 are provided on the right side of the start lever 10 and unitized by the stop button unit 14. Also, the left stop button 11, the middle stop button 12 and the right stop button 13 are provided to detect a stop operation by the player to stop a left reel 17a, a middle reel 17b and a right reel 17c from spinning. Hereinafter, the left stop button 11, the middle stop button 12 and the right stop button 13 may be collectively referred to as “stop buttons 11, 12 and 13.” In addition, the stop buttons 11, 12 and 13 include stop button performance lamps (not shown), respectively. Then, the sub-control board 400 controls the lighting and blinking of the stop button performance lamp, based on that a predetermined condition is met. By this means, it is possible to present a performance which appeals to the player's eyes.

<Return Button 15>

A return button 15 is provided on the right side of the stop button unit 14. When a medal inserted into the medal insertion slot 6 is jammed in a selector 16, the return button 15 is used to return the jammed medal.

<Selector 16>

The selector 16 is provided in the medal insertion slot 6 to determine whether or not the material and shape of the medal inserted into the medal insertion slot 6 is appropriate. A medal sensor 16s is provided in the selector 16 to detect an appropriate medal passing through. Then, when the medal sensor 16s determines that the medal inserted into the medal insertion slot 6 is appropriate, a hopper guide member 522 guides this appropriate medal to a hopper 520. On the other hand, when the medal sensor 16s determines that the medal inserted into the medal insertion slot 6 is not appropriate, a guide member 523 ejects the medal from a medal payout slot 33.

<Left Reel 17a, Middle Reel 17b, Right Reel 17c, and Reel Unit 17d>

The left reel 17a, the middle reel 17b and the right reel 17c are provided in the cabinet 2 and each has a cylindrical structure. In addition, a translucent sheet is attached to the peripheral surface of the cylindrical structure of each of the left reel 17a, the middle reel 17b and the right reel 17c, and has a plurality of kinds of symbols which are arranged in a line. Then, stepping motors 101, 102 and 103 are excited to spin the left reel 17a, the middle reel 17b and the right reel 17c, so that a plurality kinds of symbols on each reel are sequentially displayed as the reel is spinning. With the present embodiment, the left reel 17a, the middle reel 17b and the right reel 17c are unitized as a reel unit 17d and easily attached to and detached from the game machine 1. Hereinafter, the left reel 17a, the middle reel 17b and the right reel 17c may be collectively referred to as “reels 17”.

<Performance Button 18>

A performance button 18 is provided on the right side of the max-bet button 8 and used to control a liquid crystal (LC) display device 41 by the sub-control board 400 when the player's operation is detected during a predetermined performance. Here, the performance button 18 may not be provided, but the one-bet button 7 and the max-bet button 8 may serve as the performance button 18. In this case, a command is sent to the sub-control board 400 based on that the one-bet button 7 or the max-bet button 8 is operated, and the sub-control board 400 controls the LC display device 41, based on that the sub-control board 400 has received the command. By this means, the performance button 18 does not need to be provided separately, so that it is possible to reduce the number of parts. In addition, a performance button lamp (not shown) is built in the performance button 18. Then, the sub-control board 400 controls the lighting and blinking of the performance button lamp, based on that a predetermined condition is met. By this means it is possible to present a performance which appeals to the player's eyes.

<Numerical Keypad 19>

A numerical keypad 19 is provided on the right side of the performance button 18 and can be pushed in at least two directions (usually in four directions) to accept the player's operation.

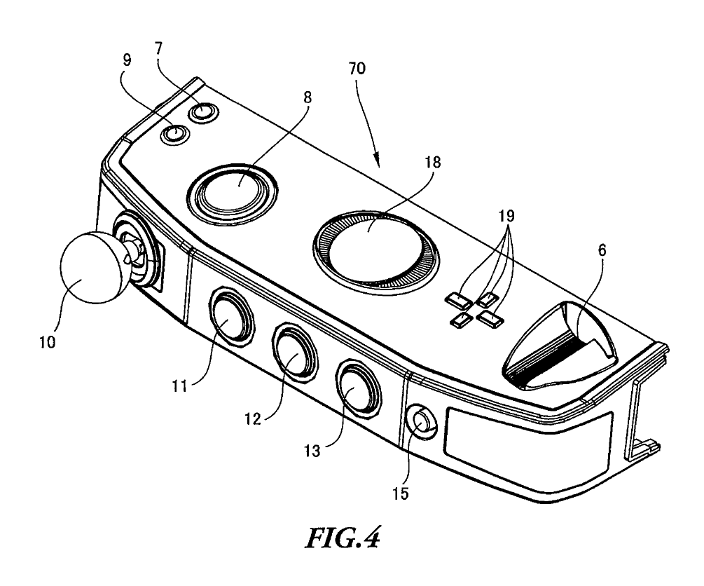

The above-described medal insertion slot 6, the one-bet button 7, the max-bet button 8, the adjustment button 9, the start lever 10, the left stop button 11, the middle stop button 12, the right stop button 13, the return button 15, the performance button 18 and the numerical keypad 19 are provided on a control panel 70 as shown in FIG. 4. The control panel 70 is unitized, and can be removed from the front door 3 as a single unit. Therefore, if the above-described components provided on the control panel 70 fail and need to be fixed or replaced, there is no need to detach or replace the entire front door 3 but only the control panel 70 can be detached or replaced, so that it is possible to ensure the ease of maintenance.

<Panel 20 and Display Window 21>

A panel 20 is provided to display performance lamps 22a to 22j, a start lamp 23, bet lamps 24a to 24c, an accumulated medal number display 25, a game state display lamp 26, a payout number display 27, an insertion possible display lamp 28, a replay display lamp 29, and stop operation order display lamps 30a to 30c. In addition, a display window 21 is provided in the panel 20 to allow the left reel 17a, the middle reel 17b and the right reel 17c to be seen and recognized.

<Performance Lamps 22a to 22j>

Performance lamps 22a to 22j are provided on the rear surface of the translucent portions of the panel 20 on its right and left edges and are lit under predetermined conditions to inform the current state (for example, an ART state). The performance lamps 22a to 22e are provided on the left side of the display window 21, and the performance lamps 22f to 22j are provided on the right side of the display window 21. Hereinafter, the performance lamps 22a to 22j may be collectively referred to as “performance lamps 22.”

<Start Lamp 23>

The start lamp 23 is provided above the one-bet button 7 to inform whether or not it is possible to accept the start operation of the start lever 10. To be more specific, in a case in which three medals are inserted into the medal insertion slot 6, or in a case in which the max-bet button 8 is operated while the number of accumulated medals is three, the start lamp 23 is lit to inform that it is possible to accept the start operation by the start lever 10.

<Bet Lamps 24a to 24c>

The bet lamps 24a to 24c are provided on the right side of the start lamp 23 to inform the number of inserted medals to be used for a game. To be more specific, when the number of inserted medals is one, the bet lamp 24a is lit; when the number of inserted medals is two, the bet lamp 24b is lit; and when the number of inserted medals is three, the bet lamp 24c is lit. Hereinafter, the bet lamps 24a to 24c may be collectively referred to as “bet lamps 24”.

<Accumulated Medal Number Display 25>

The accumulated medal number display 25 is provided on the right side of the bet lamp 24. Also the accumulated medal number display 25 is provided to display the number of medals which belong to the player and are accumulated in the game machine 1.

<Game State Display Lamps 26a and 26b>

The game state display lamps 26a and 26b are provided on the right side of the accumulated medal number display 25. The main control board 300 controls the lighting of the game state display lamps 26a and 26b, so that the current game state is informed. Hereinafter, the game state display lamps 26a and 26b may be collectively referred to as “game state display lamps 26”.

<Payout Number Display 27>

The payout number display 27 is provided on the right side of the game state display lamp 26b. The payout number display 27 is provided to display the number of medals to be paid out according to the number of medals inserted into the medal insertion slot 6, or a combination of the symbols arranged on a pay line which is enabled by operating the one-bet button 7 or the max-bet button 8. Here, with the present embodiment, three symbols are displayed for each of the left reel 17a, the middle reel 17b and the right reel 17c in the display window 21. Here, the pay line means a falling diagonal line from left to right obtained by connecting the symbol of the upper stage of the left reel 17a, the symbol of the middle stage of the middle reel 17b and the symbol of the lower stage of the right reel 17c.

Hereinafter, the straight line obtained by connecting the symbol of the upper stage of the left reel 17a, the symbol of the upper stage of the middle reel 17b and the symbol of the upper stage of the right reel 17c may be referred to as “upper stage” or “upper stage line.” In addition, the straight line obtained by connecting the symbol of the middle stage of the left reel 17a, the symbol of the middle stage of the middle reel 17b and the symbol of the middle stage of the right reel 17c may be referred to as “middle stage” or “middle stage line.” Moreover, the straight line obtained by connecting the symbol of the lower stage of the left reel 17a, the symbol of the lower stage of the middle reel 17b and the symbol of the lower stage of the right reel 17c may be referred to as “lower stage” or “lower stage line.” Furthermore, the straight line obtained by connecting the symbol of the lower stage of the left reel 17a, the symbol of the middle stage of the middle reel 17b and the symbol of the upper stage of the right reel 17c may be referred to as “diagonally right up” or “a rising diagonal line from left to right.”

<Insertion Possible Display Lamp 28>

The insertion possible display lamp 28 is provided on the right side of the payout number display 27. The insertion possible display lamp 28 is lit to inform that it is possible to accumulate the medal which has just been inserted into the medal insertion slot 6. Meanwhile, the insertion possible display lamp 28 is turned off to inform that it is not possible to accumulate the medal which has just been inserted into the medal insertion slot 6.

Here, with the present embodiment, the maximum number of medals that can be credited is “50”. Therefore, when the number of the accumulated medals is smaller than “50”, the main control board 30 performs the control to light the insertion possible display lamp 28, and, meanwhile, when the number of the accumulated medals is “50”, the main control board 30 performs the control to turn off the insertion possible display lamp 28. In addition, when a combination of symbols that is associated with “replay” (described later) is displayed on the pay line, the main control board 30 performs the control to turn off the insertion possible display lamp 28.

<Replay Display Lamp 29>

The replay display lamp 29 is provided below the insertion possible display lamp 28. The replay display lamp 29 is lit when the combination of symbols which is associated with a replay is displayed on the pay line. By this means, it is possible to inform the player that the combination of symbols which is associate with the replay on the pay line. This also informs the player that it is possible to play a next game without consuming a medal.

<Stop Operation Order Display Lamps 30a to 30c>

The stop operation order display lamps 30a to 30c are provided below the display window 21. To be more specific, the stop operation order display lamp 30a is provided below the left reel 17a; the stop operation order display lamp 30b is provided below the middle reel 17b; and the stop operation order display lamp 30a is provided below the right reel 17c. In addition, the stop operation order display lamps 30a to 30c are provided to inform the player of the optimum order to stop the left stop button 11, the middle stop button 12 and the right stop button 13, based on a win area determined by the main control board 300. To be more specific, at the optimum time to stop the left stop button 11, the stop operation order display lamp 30a is lit or blinked; at the optimum time to stop the middle stop button 12, the stop operation order display lamp 30b is lit or blinked; and at the optimum time to stop the right stop button 13, the stop operation order display lamp 30c is lit or blinked. By this means, the player is informed of the order.

<Waist Part Panel 31>

A waist part panel 31 is provided below the stop button unit 14 to allow the player to recognize the model name, the motif and so forth of the game machine 1. To be more specific, the illustrations of the characters are drawn on the waist part panel 31. In addition, a light (not shown) is provided on the rear surface of the waist part panel 31, and the sub-control board 400 controls the lighting of the light, so that the player can easily recognize the model name, the motif and so forth of the game machine 1.

<Tray Unit 32>

A tray unit 32 is provided below the waist part panel 31 to receive and accumulate the medals discharged from the medal payout slot 33.

<Medal Payout Slot 33>

In a case in which medals are paid out based on the combination of symbols displayed on the pay line, when the hopper 520 is driven, the medal payout slot 33 is used to discharge the medals which the hopper has paid out. In addition, when the medal sensor 16s determines that the medal inserted into the medal insertion slot 6 is not appropriate, or when a medal is inserted into the medal insertion slot 6 despite that the medal insertion slot 6 is not allowed to accept any medal, the medal payout slot 33 is used to discharge the medal inserted into the medal insertion slot 6 to the tray unit 32.

Here, the case in which the medal insertion slot 6 is not allowed to accept any medal is, for example, a case in which the left reel 17a, the middle reel 17b and the right reel 17c are spinning, or a case in which the combination of symbols which is associated with a replay is displayed on the pay line.

<Lower Speakers 34a and 34b>

Lower speakers 34a and 34b are provided on the right and left sides of the medal payout slot 33 to output BGM, voice, and special effects during a performance. Hereinafter, the lower speakers 34a and 34b may be collectively referred to as “lower speakers 34”.

<Upper Speakers 35a and 35b>

Upper speakers 35a and 35b are provided on the right and left sides of the LC display device 41 to output BGM, voice and special effects during a performance, like the lower speakers 34a and 34b. Hereinafter, the upper speakers 35a and 35b may be collectively referred to as “upper speakers 35”, and the lower speakers 34a and 34b, and the upper speakers 35a and 35b may be referred to as “speakers 34 and 35”.

<Setting Display Part 36>

A setting display part 36 is provided to display the current setting value. To be more specific, when a setting change key (not shown) is inserted into a key hole (not shown) and turned for a predetermined angle, the setting value which is currently set is displayed on the setting display part 36 under the control of the main control board 300.

<Setting Change Button 37>

A setting change button 37 is provided to change setting values. Here, when a setting value is changed, first, a setting change key (not shown) is inserted into the key hole and rotated for a predetermined angle. Next, the setting change button 37 is operated so as to be able to change the setting value on the setting display part 36. Then, when a value that is intended to be set as the setting value is displayed on the setting display part 36 by operating the setting change button 37, the start lever 10 is operated to return the angle of the rotated setting change key to the angle that allows the setting change key to be taken out, so that it is possible to change the setting value.

Here, with the present embodiment, the setting value can be changed in six steps from “1” to “6”. When the setting change button 37 is operated while “1” is displayed on the setting display part 36, “2” is displayed on the setting display part 36. Subsequently, the setting value is incremented by one every time the setting change button 37 is operated. Here, when the setting change button 37 is operated while “6” is displayed on the setting display part 36, “1” is displayed on the setting display part 36.

<LC Display Device 41>

The LC display device 41 is provided on the reels 17 to present performances with the displays of moving images and still images. In addition, the LC display device 41 is used to provide the information on the result of an internal lottery process (described later) and also provide information required to stop and display the combination of symbols for a win on the pay line.

Moreover, with the present embodiment, a drive mechanism is provided to move the LC display device 41 upward and downward. By this means, it is possible to allow the sub-control board 400 to move the LC display device 41 to move upward and downward, based on a predetermined condition is met.

<Main Control Board 300>

The main control board 300 is provided above the reels 17 in the cabinet 2 to control the game machine 1. The main control board 300 will be described in detail later.

<Sub-Control Board 400>

The sub-control board 400 is provided in the upper part of the rear surface of the front door 3 to control the LC display device 41, the speakers 34 and 35. The sub-control board 400 will be described in detail later.

<Power-Supply Unit 510>

A power-supply unit 510 is provided in the cabinet 2 to supply a voltage to the game machine 1.

<Hopper 520>

The hopper 520 is provided in the cabinet 2 to pay out medals to the player. In addition, the drive of the hopper 520 is controlled based on a predetermined signal from the main control board 300. The power-supply board 500 determines whether or not a predetermined number of medals has been discharged based on the medal sensor (not shown) provided on the hopper 520, and, when determining that the predetermined number of medals has been discharged, transmits a signal indicating that the payout has been done to the main control board 300. By this means, the main control board 300 can recognize that the payout has been done.

<Discharge Slit 521>

A discharge slit 521 is provided in the hopper 520 to discharge a medal from the hopper 520.

<Hopper Guide Member 522>

The hopper guide member 522 is provided to guide a medal having just been inserted into the medal insertion slot 6 to the hopper 520 provided in the cabinet 2 when the medal sensor 16s determines that the medal is appropriate.

<Guide Member 523>

When the medal insertion slot 6 receives an object different from a medal, or when the medal sensor 16s determines that a medal having just been inserted into the medal insertion slot 6 is not appropriate, the guide member 523 guides the object or the inappropriate medal to the medal payout slot 33.

<Payout Guide Member 524>

A payout guide member 524 is provided to guide the medal discharged from the discharge slit 521 in the hopper 520 to the medal payout slot 33 in the tray unit 32.

<Auxiliary Accumulating Part 530>

An auxiliary accumulating part 530 is provided to accommodate overflow medals from the hopper 520.

<The Structure of the Start Lever>

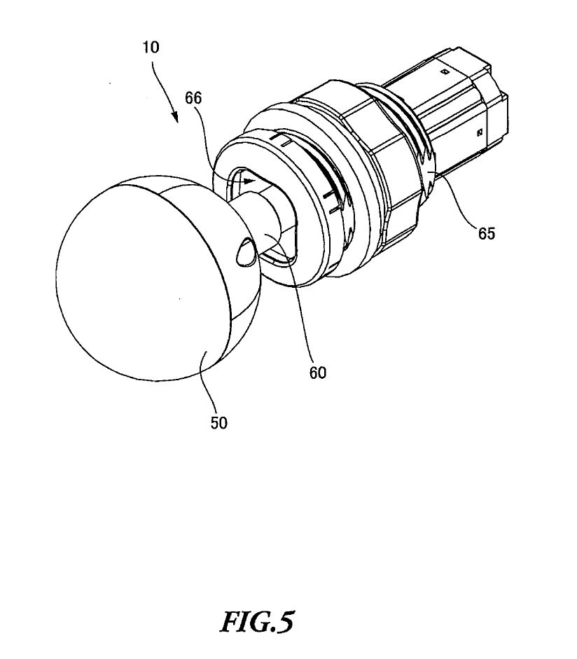

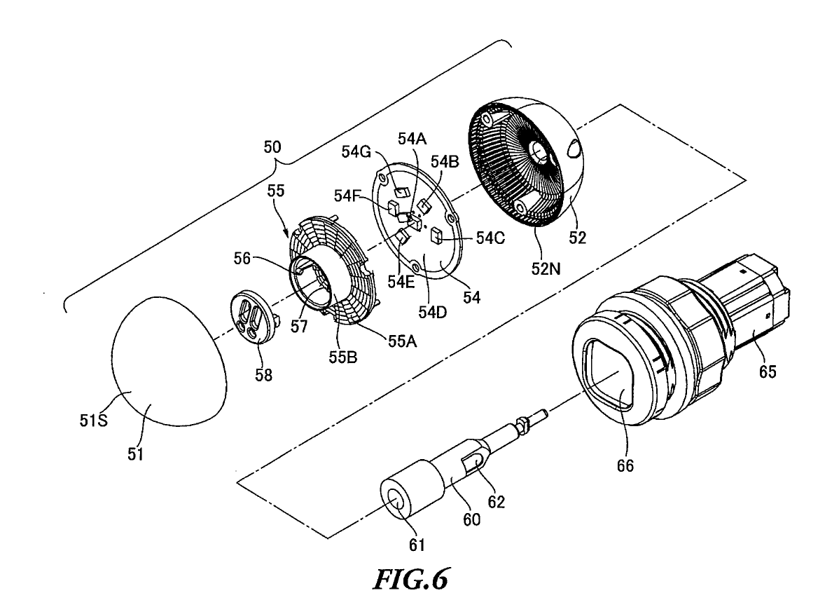

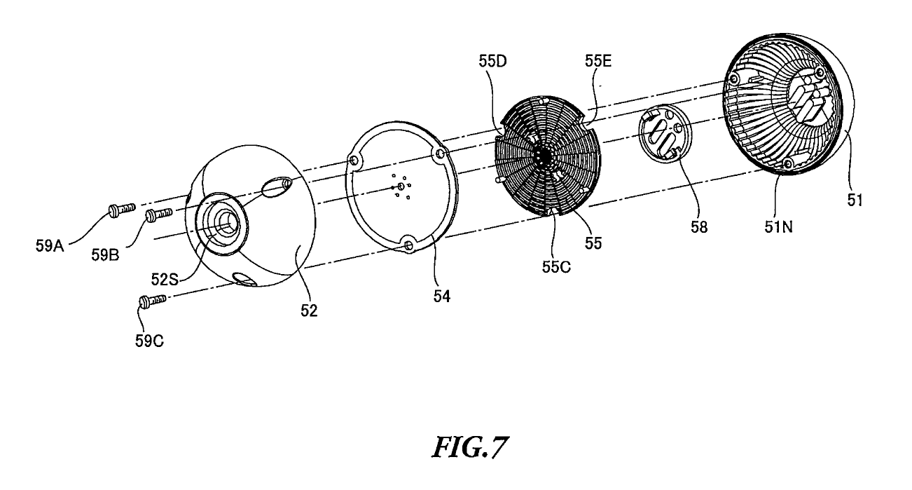

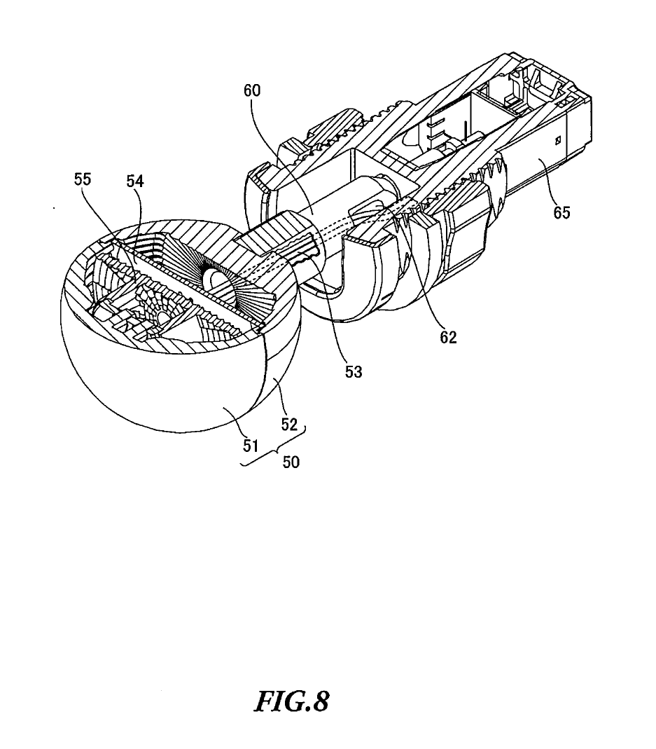

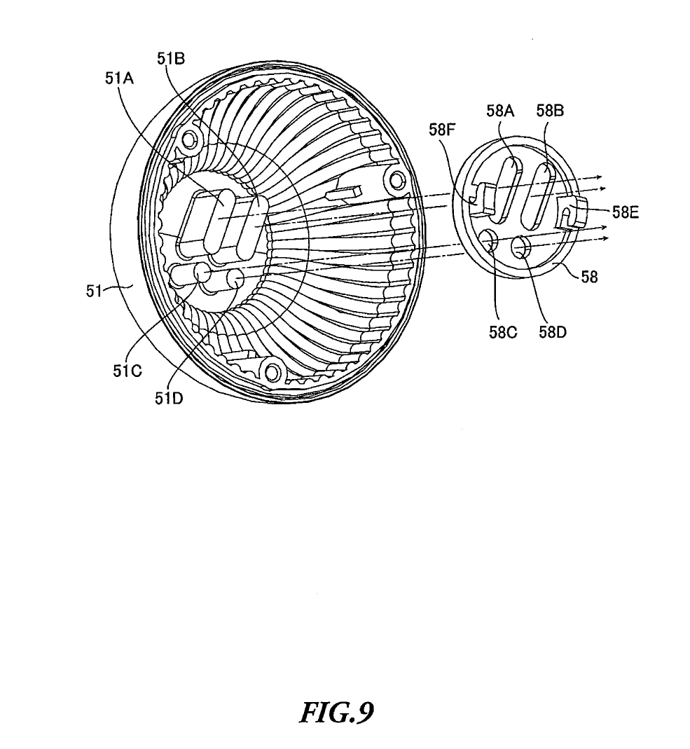

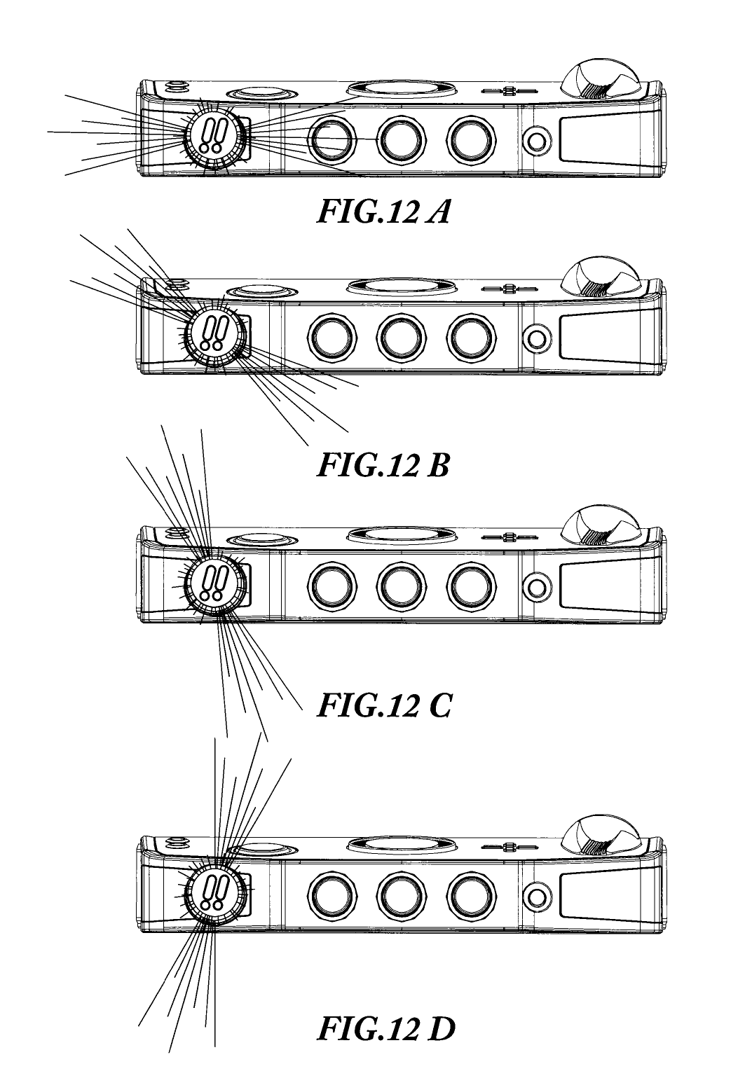

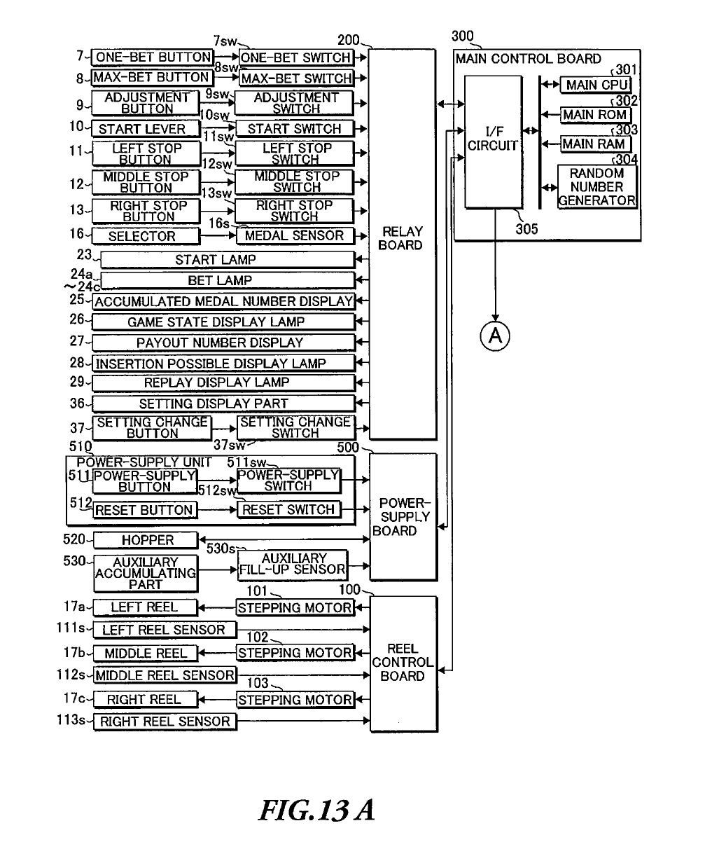

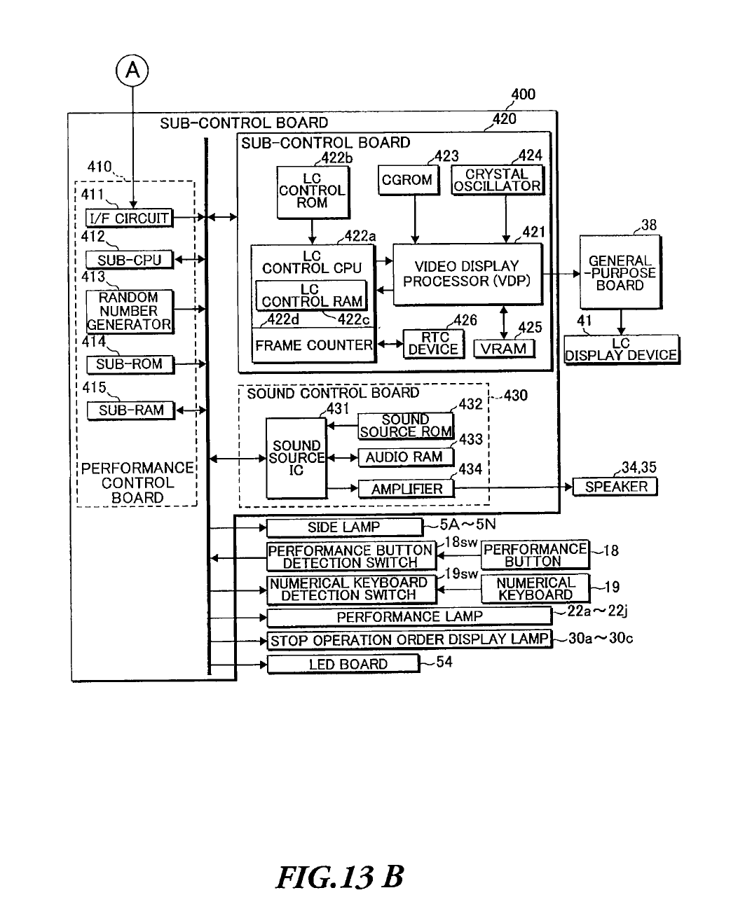

Next, the start lever 10 will be described in detail with reference to FIG. 5 to FIG. 12. FIG. 5 is a drawing showing the entire start lever. FIG. 6 and FIG. 7 each show the start lever separated into parts. FIG. 8 is a schematic cross-sectional view showing the start lever. FIG. 9 to FIG. 11 are drawings explaining the internal structure of the knob of the start lever. FIG. 12 shows examples of lighting modes of the start lever.

FIG. 5 shows the entire start lever 10. The start lever 10 is held by a bias member (not shown) in a frame 65 in a horizontal position while a shaft 60 protruding from the knob 50 having an approximately spherical shape. The shaft 60 can swing within the range of an opening 66 of the frame 65. In addition, a start switch 10sw is provided in the vicinity of the rear end (opposite to the knob, that is, in the frame 65 side). This start switch 10sw detects the change in position of the shaft 60 due to the swing of the start lever 10 and outputs a detection signal to the main control board 300.

FIG. 6 and FIG. 7 are exploded perspective views showing the start lever 10. FIG. 6 is an exploded perspective view showing the knob 50 from the front side (opposite to the side in which the shaft 60 protrudes). FIG. 7 is an exploded perspective view showing the knob 50 from the rear side (in which the shaft protrudes).

The knob 50 has an approximately spherical shape by combining an approximately hemispherical front body 51 with an approximately hemispherical rear body 52. As shown in FIG. 6, a stopper 58, an inner lens 55 and an LED board 54 are arranged in the knob 50 from the front body 51 side. While the LED board 54, the stopper 58 and the inner lens 55 are sandwiched between the front body 51 and the rear body 52, the front body 51, the LED board 54 and the rear body 52 are fixed to each other by screws 59A, 59B and 59C from the rear surface side of the rear body 52 (from the side in which the shaft 60 protrudes) as shown in FIG. 7.

A number of protrusions are provided in the front body 51, which extend radially from a front end 51S of the semispherical front body 51 to a connecting portion 51N that is connected to the rear body 52. Likewise, a number of protrusions are provided in the rear body 52, which extend radially from a front end 52S of the semispherical rear body 52 to a connecting portion 52N that is connected to the front body 51.

Six LEDs (an LED 54B, an LED 54C, an LED 54D, an LED 54E, an LED 54F and an LED 54G) are arranged at regular intervals on the LED board 54 to surround the circumference of the LED 54A disposed at the center of the LED board 54. As shown in FIG. 8, a wire 53 extending from the LED board 54 penetrates a through hole 61 in the shaft 60 and extends from an opening 62 provided in the rear end side of the shaft 60 to the outside of the shaft 60. This extending wire 53 is connected to the sub-control board 400.

The inner lens 55 is constituted by a lens body 55A which is concentrically and radially faceted and a cylindrical engagement part 55B having convex portions 56 and 57 to engage with the stopper 58. The cylindrical engagement part 55B is formed on the lens body 55A. In addition, approximately semicircular cutouts 55C, 55D and 55E that allow the screws 59A to 59C to pass through are formed in the inner lens 55. These screws 59A to 59C are inserted and fixed in the cutouts 55C and 55E to prevent the inner lens 55 from rotating in the knob 50. Here, “rotating” means that the inner lens 55 rotates about the axis obtained by connecting between the front end 51S of the front body 51 and the front end 52S of the rear body 52. Hereinafter, the same applies to any component in the knob 50.

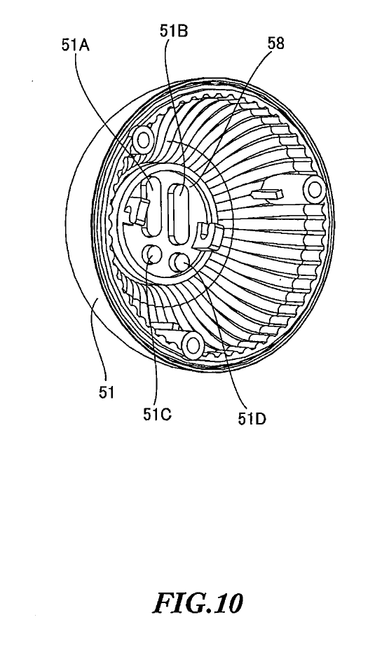

Fitting holes 58A to 58D are formed in the stopper 58, and protrusions 51A to 51D in the front body 51 are fitted into the fitting holes 58A to 58D, respectively. FIG. 9 shows a state before the front body 51 engages with the stopper 58. FIG. 10 shows a state in which the front body 51 engages with the stopper 58. As shown in FIG. 10, each of the protrusions 51A to 51D in the front body 51 has enough length to penetrate the fitting holes 58A to 58D of the stopper 58 and to protrude from the rear surface side of the stopper 58 (to face the connecting portion 51N), when the stopper 58 engages with the front body 51. In this way, the stopper 58 engages with the front body 51, and therefore it is possible to prevent the stopper 58 from rotating by itself in the knob 50.

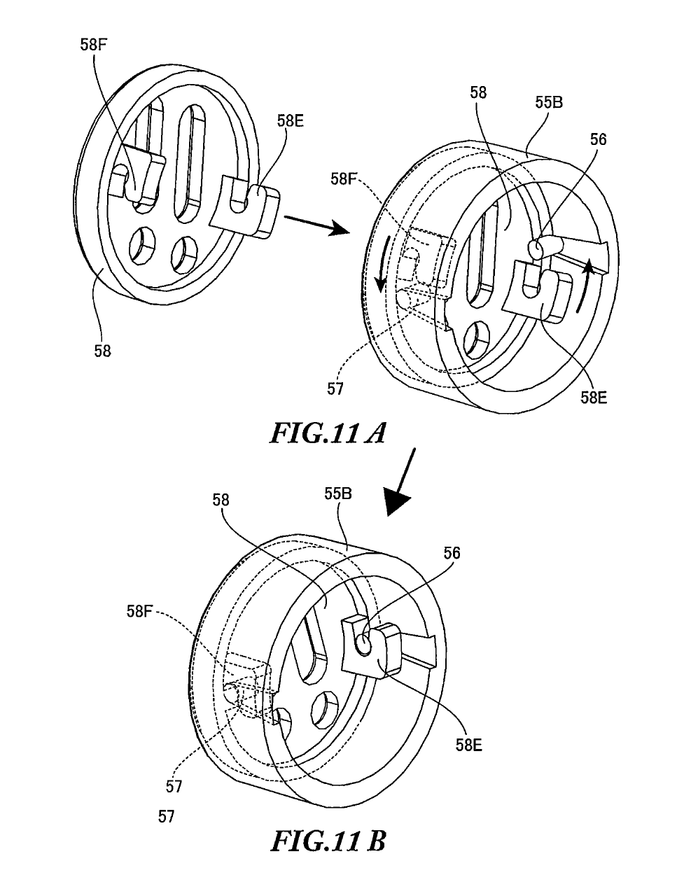

Moreover, concave portions 58E and 58F are provided in the stopper 58 to lock the inner lens 55. Here, in order to engage the stopper 58 with the inner lens 55, it is necessary to change the state from the state shown in FIG. 11A to the state shown in FIG. 11B. That is, the concave portions 58E and 58F of the stopper 58 engage with the convex portions 56 and 57 of the inner lens 55 to engage the stopper 58 with the inner lens 55.

As described above, the stopper 58 is fitted in the front body 51 and engaged with the inner lens 55. Here, in a process to finish the knob 50, first, the stopper 58 is locked in the inner lens 55, and then, the stopper 58 locked in the inner lens 55 is engaged with the front body 51. With this process, it is possible to firmly fix the inner lens 55 in the front body 51 via the stopper 58. That is, the front body 51 and the stopper 58 can prevent the inner lens 55 from rotating in the knob 50.

With the start lever 10 having the above-described configuration, it is possible to provide the lighting mode, for example, as shown in FIG. 12. In FIG. 12, the LEDs 54B to 54G on the LED board 54 in the knob 50 are lit, blinked and turned off in turn clockwise, so that it is possible to show as if the light is rotating in the start lever 10 (knob 50). This lighting mode is provided by the sub-control board 400, based on that a predetermined condition is met. In addition, the lighting modes of the side lamp 5 and the stop buttons 11, 12 and 13 may be changed according to the lighting mode of the start lever 10. By this means, it is possible to inform the player that a predetermined condition is met (for example, a specific lottery result is acquired in the internal lottery process) based on not only the lighting mode of the start lever 10 but also the lighting modes of the other switches and lamps.

In addition, the start lever 10 is operated to output a detection signal to the main control board 300, and to provide various lighting modes according to commands outputted from the sub-control board 400.

In addition, the knob 50 is formed by the front body 51 and the rear body 52 that can be easily separated from one another by removing the screws 59A to 59C. Therefore, even if the members in the knob 50, which are the LED board 54, the inner lens 55 and the stopper 58, fail, it is possible to easily check these members, and therefore to simplify the maintenance.

Here, with the present embodiment, the start lever 10 is an exemplary operation device according to the present invention. In addition, with the present embodiment, the start switch 10sw is an exemplary detection means according to the present invention. Moreover, with the present embodiment, the knob 50 constituted by the front body 51, the rear body 52, the LED board 54, the inner lens 55 and the stopper 58 is an exemplary operation part according to the present invention. Here, the LED board 54 is equivalent to an exemplary light source board according to the present invention, and the shaft 60 is equivalent to an exemplary transmission part according to the present invention. Furthermore, the inner lens 55 provided between the front body 51 and the LED board 54 is equivalent to an exemplary lens member according to the present invention.

<Block Diagram Showing the Entire Game Machine>

Next, the configuration of the game machine 1 according to the present invention will be described in detail with reference to FIGS. 13A and 13B.

In the game machine 1, a reel control board 100, a rely board 200, the sub-control board 400 and the power source board 500 are connected to the main control board 300 that controls main operations of the game machine 1.

<Main Control Board 300>

A main CPU 301, a main ROM 302, a main RAM 303, a random number generator 304 and an I/F (interface) circuit 305 are connected to the main control board 300.

<Main CPU 301>

The main CPU 301 reads a program stored in the main ROM 302 and performs predetermined arithmetic processing along with the progression of the game to transmit a predetermined signal to the reel control board 100, the relay board 200, the sub-control board 400 and the power-supply board 500.

<Main ROM 302>

The main ROM 302 stores the control program performed by the main CPU 301, data tables such as a win area determination table, and data to transmit a command to the sub-control board 400.

<Main RAM 303>

The main RAM 303 includes a storage area to store various data determined by executing the program by the main CPU 301. In addition, the main RAM 303 serves to temporarily store the result of the calculation by the main CPU 301.

<Random Number Generator 304>

The random number generator 304 is provided to generate random numbers to determine a win area and so forth. Here, with the present embodiment, the random number generator 304 generates random number values within the range from “0” to “65535”.

<IF Circuit 305>

The IF circuit 305 is provided to transmit and receive commands between the main control board 300 and the other boards, the reel control board 100, the relay board 200, the sub-control board 400 and the power-supply unit board 500.

<Relay Board 200>

The following components are connected to the relay board 200: a one-bet switch 7sw; a max-bet switch 8sw; an adjustment switch 9sw; the start switch 10sw; a left stop switch 11sw; a middle stop switch 12sw; a right stop switch 13sw; the medal sensor 16s; the start lamp 23; the bet lamp 24; the accumulated medal number display 25; the game state display lamp 26; the payout number display 27; the insertion possible display lamp 28; the replay display lamp 29; the setting display 36; and a setting change switch 37sw.

<One-Bet Switch 7sw>

The one-bet switch 7sw is provided to detect the one-bet button 7 being operated by the player. When the one-bet switch 7sw detects the one-bet button 7 being operated by the player, the relay board 200 transmits a predetermined signal to the I/F circuit 305 in the main control board 300. Then, the main CPU 301 controls such that the player uses one of the accumulated medals, based on that the I/F circuit 305 has received the predetermined signal from the relay board 200.

<Max-Bet Switch 8sw>

The max-bet switch 8sw is provided to detect the max-bet button 8 being operated by the player. When the max-bet switch 8sw detects the max-bet button 8 being operated by the player, the relay board 200 transmits a predetermined signal to the I/F circuit 305 in the main control board 300. Then, the main CPU 301 controls such that the player uses three of the accumulated medals, based on that the I/F circuit 305 has received the predetermined signal from the relay board 200. Hereinafter, the one-bet switch 7sw and the max-bet switch 8sw may be collectively referred to as “bet switches 7sw and 8sw.

<Adjustment Switch 9sw>

The adjustment switch 9sw is provided to detect the adjustment button 9 being operated by the player. When the adjustment switch 9sw detects the adjustment button 9 being operated by the player, the relay board 200 transmits a predetermined signal to the I/F circuit 305 in the main control board 300. Then, the main CPU 301 outputs a signal to the hopper 520 in the power-supply board 500 to return the accumulated medals, based on that the I/F circuit 305 has received the predetermined signal from the relay board 200, so that the hopper 520 returns the accumulated medals.

<Start Switch 10sw>

The start switch 10sw is provided to detect the start lever 10 being operated by the player. When the start switch 10sw detects the start lever 10 being detected by the player, the relay board 200 transmits a predetermined signal to the I/F circuit 305 in the main control board 300. Then, the main CPU 301 controls such that spin of the reels 17 is started, based on that the I/F circuit 305 has received the predetermined signal from the relay circuit 200.

<Left Stop Switch 11sw>

The left stop switch 11sw is provided to detect the left stop button 11 being operated by the player. When the left stop switch 11sw detects the left stop button 11 being operated by the player, the relay board 200 transmits a predetermined signal to the I/F board 305 in the main control board 300. Then, the main CPU 301 controls to stop the left reel 17a from spinning, based on that the I/F circuit 305 has received the predetermined signal from the relay board 200.

<Middle Stop Switch 12sw>

The middle stop switch 12sw is provided to detect the middle stop button 12 being operated by the player. When the middle stop switch 12sw detects the middle stop button 12 being operated by the player, the relay circuit 200 transmits a predetermined signal to the I/F circuit 305 in the main control board 300. Then, the main CPU 301 controls to stop the middle reel 17b from spinning, based on that the I/F circuit 305 has received the predetermined signal from the relay board 200.

<Right Stop Switch 13sw>

The right stop switch 13sw is provided to detect the right stop button 13 being operated by the player. When the right stop switch 13sw detects the right stop button 13 being operated by the player, the relay board 200 transmits a predetermined signal to the I/F circuit 305 in the main control board 300. Then, the main CPU 301 controls to stop the right reel 17c from spinning, based on that the I/F circuit 305 has received the predetermined signal from the relay board 200. Hereinafter, the left stop switch 11sw, the middle stop switch 12sw, and the right stop switch 13sw may be collectively referred to as “stop switches 11sw, 12sw and 13sw.”

Here, with the present embodiment, the stop switches 11sw, 12sw and 13sw can detect the stop buttons 11, 12 and 13 being turned on and off. Therefore, the stop switches 11sw, 12sw and 13sw can detect the stop buttons 11, 12 and 13 being operated by the player, that is, the stop buttons 11, 12 and 13 being turned on, and also detect the finger of the player releasing the stop buttons 11, 12 and 13, that is, the stop buttons 11, 12 and 13 are turned off after the player operates the stop buttons 11, 12 and 13.

<Medal Sensor 16s>

The medal sensor 16s is provided to detect the medal inserted into the medal insertion slot 6 passing through the selector 16. When the medal sensor 16s detects the medal successfully passing through the selector 16, the relay board 200 transmits a predetermined signal to the I/F circuit 305 in the main control board 300. Then, the main CPU 301 performs control for the medal insertion, based on that the I/F circuit 305 has received the predetermined signal from the relay board 200.

<Setting Change Switch 37sw>

The setting change switch 37 is provided to detect the setting change button 37 being operated. When the setting change switch 37sw detects the setting change button 37 being operated, the relay board 200 transmits a predetermined signal to the I/F circuit 305 in the main control board 300. Then, the main CPU 301 performs control for changing and displaying the setting value on the setting display part 36, based on that the I/F circuit 305 has received the predetermined signal from the relay board 200.

<Power-Supply Board 500>

The power-supply unit 510, the hopper 520 and an auxiliary fill-up sensor 530s are connected to the power-supply board 500.

<Power-Supply Unit 510>

The power-supply unit 510 includes a power-supply switch 511sw and a reset switch 512sw. These switches are connected to the power-supply board 500 via the power-supply unit 510.

<Power-Supply Switch 511sw>

The power-supply switch 511sw is provided to detect the power-supply button 511 being operated by a staff member of the game parlor. When the power-supply switch 511sw detects the power-supply button 511 being operated by the staff member, the power-supply board 500 transmits a predetermined signal to the I/F circuit 305 in the main control board 300. The power-supply board supplies a voltage to the entire game machine 1, based on that the power-supply switch 511sw detects the power-supply button 511 being operated by the staff member.

<Reset Switch 512sw>

The reset switch 512sw is provided to detect the reset button 512 being operated by a staff member of the game parlor. When the reset switch 512sw detects the reset button 512 being operated by the staff member, the power-supply board 500 transmits a predetermined signal to the I/F circuit 305 in the main control board 300. By this means, it is possible to stop outputting an error signal and so forth, and therefore to recover from an error condition.

<Auxiliary Fill-Up Sensor 530s>

The auxiliary fill-up sensor 530s is provided to detect the number of medals accumulated in the auxiliary accumulation part 530 being above a predetermined number. When the auxiliary fill-up sensor 530s detects the number of medals accumulated in the auxiliary accumulation part 530 being above the predetermined number, the power-supply board 500 outputs a signal to indicate that the number of medals accumulated in the auxiliary accumulation part 530 is above the predetermined number, to the I/F circuit 305 in the main control board 300. Then, when the I/F circuit 305 receives the signal indicating that the number of medals accumulated in the auxiliary accumulation part 530 is above the predetermined number, the main control board 300 performs control to display a predetermined error. Then, when the error is displayed, the player calls for a staff member of the game parlor, and then the staff member collects the medals and operates the reset button 512, so that the error condition is recovered to a normal condition that can restart the game.

<Reel Control Board 100>

Stepping motors 101, 102 and 103, a left reel sensor 111s, a middle reel sensor 112s and a right reel sensor 113s are connected to the reel control board 100.

<Stepping Motors 101, 102 and 103>

The stepping motors 101, 102 and 103 are provided to spin the left reel 17a, the middle reel 17b and the right reel 17c, respectively. The momentum of each of the stepping motors 101, 102 and 103 is proportional to the number of pulses, and its axis of rotation can be stopped at a designated angle. The driving forces of the stepping motors 101, 102 and 103 are transmitted to the left reel 17a, the middle reel 17b and the right reel 17c, respectively, via a gear with a predetermined reduction gear ratio. By this means, the left reel 17a, the middle reel 17b and the right reel 17c spin at a predetermined angle every time a pulse is outputted to the stepping motors 101, 102 and 103. Here, the main CPU 301 controls the spin angles of the left reel 17a, the middle reel 17b and the right reel 17c by detecting the reel index and then counting the number of times the pulses are outputted to the stepping motors 101, 102 and 103.

<Left Reel Sensor 111s>

The left reel sensor 111s includes an optical sensor having a light-emitting part and a light-receiving part, and is configured to detect the reel index indicating that the left reel 17a spins through 360 degrees.

<Middle Reel Sensor 112s>

The middle reel sensor 112s includes an optical sensor having a light-emitting part and a light-receiving part, and is configured to detect the reel index indicating that the middle reel 17b spins through 360 degrees.

<Right Reel Sensor 113s>

The right reel sensor 113s includes an optical sensor having a light-emitting part and a light-receiving part, and is configured to detect the reel index indicating that the right reel 17c spins through 360 degrees.

<Sub-Control Board 400>

The sub-control board 400 principally controls performances. The following components are connected to the sub-control board 400: a performance control board 410; an image control board 420; a sound control board 430; the side lamp 5; a performance button detection switch 18sw; a numerical keyboard detection switch 19sw; the performance lamps 22; the stop operation order display lamps 30; and the LED board 54.

<Performance Button Detection Switch 18sw>

The performance button detection switch 18sw is provided to detect the performance button 18 being operated by the player. When the performance button detection switch 18sw detects the performance button 18 being operated by the player, the sub-control board 400 performs the control based on the operation of the performance button 18 by the player.

<Numerical Keyboard Detection Switch 19sw>

The numerical keyboard detection switch 19sw is provided to detect the numerical keyboard 19 being operated by the player. When the numerical keyboard detection switch 19sw detects the numerical keyboard 19 being operated by the player, the sub-control board 400 performs the control based on the operation of the numerical keyboard 19 by the player.

<Performance Control Board 410>

Primarily in a performance, the performance control board 410 controls the side lamp 5, the performance button detection switch 18sw, the performance lamp 22, the stop operation order display lamp 30, and the LED board 54. An I/F circuit 411, a sub-CPU 412, a random number generator 413, a sub-ROM 414 and a sub-RAM 415 are connected to the performance control board 410.

<I/F Circuit 411>

The I/F circuit 411 is provided to receive signals and so forth from the I/F circuit 305 in the main control board 300.

<Sub-CPU 412>

The sub-CPU 412 reads a performance program stored in the sub-ROM 414, performs a predetermined calculation based on a command from the main control board 300, and input signals from the performance button detection switch 18sw and the numerical keyboard detection switch 19sw, and supplies the result of the calculation to the image control board 420 and the sound control board 430.

<Random Number Generator 413>

The random number generator 413 is provided to generate random numbers that are used to determine performances presented by the LC display device 41, and the speakers 34 and 35. In addition, the random number generator 413 generates random numbers that are used for a lottery to move into an ART state, and also used to determine the number of additional games for the ART state.

<Sub-ROM 414>

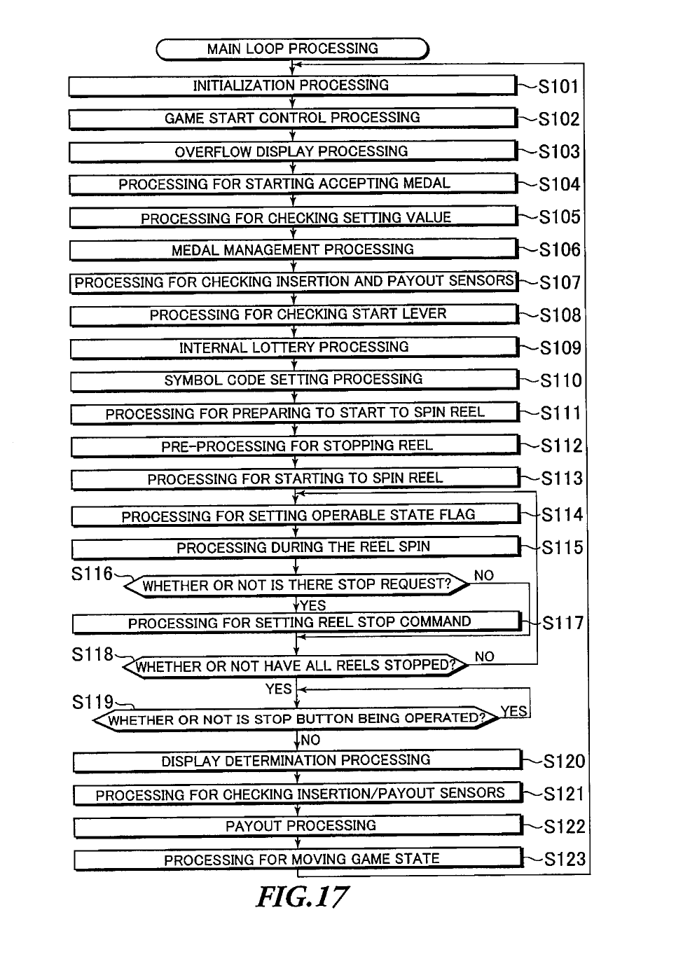

The sub-ROM 414 is provided to store a program to execute performances, a performance table, an ART lottery table and so forth. The sub-ROM 414 is mainly constituted by a program storage area and a table storage area. For example, the sub-ROM 414 includes a performance determination table to determine a performance in a bonus state (see FIG. 15).

This performance table stores performance contents such as a sure win performance that is presented when it is determined that the game will progress to a bonus game. As described in detail later, with the present embodiment, when the sure win performance is presented, the lighting is controlled in a special lighting mode such that the LEDs 54A to 54G provided in the knob 50, the stop button performance lamp and the performance button lamp (not shown) are repeatedly lit, blinked and turned off. At this time, a sound (e.g. fanfare) is outputted from the speakers 34 and 35 to inform the player of that it is determined that the game will progress to a bonus game.

<Sub-RAM 415>

The sub-RAM 415 functions as a work area for data when the sub-CPU 412 performs arithmetic processing. To be more specific, the sub-RAM 415 includes a storage area for storing various data on a win area and so forth transmitted from the main control board 300, and a storage area for storing the determined performance content and performance data. The sub-RAM 415 includes an ART storage area for storing the ART state and an ART game storage area for storing the number of ART games.

<Image Control Board 420>

The image control board 420 is provided to control the display of the LC display device 41 mainly for executing a performance. The following components are connected to the image control board 420: a video display processor (VDP) 421; an LC control CPU 422a; an LC control ROM 422b; an LC control RAM 422c; a frame counter 422d; a CGROM 423; a crystal oscillator 424; a VRAM 425 and an RTC device 426.

<Video Display Processor (VDP) 421>

The video display processor (VDP) 421 is a sort of image processor, and configured to perform control to read image data from “display frame buffer area”, which is one of the first frame buffer area and the second frame buffer area, based on a command from the LC control CPU 422a. Then, the video display processor 421 generates a video signal (e.g. an LVDS signal or RGB signal) and outputs the signal to a general-purpose board 38 to display an image on the LC display device 41. Here, the video display processor (VDP) 421 includes a control register, a CG bus I/F, a CPU I/F, a clock generation circuit, an expansion circuit, a drawing circuit, a display circuit, and a memory controller (not shown). They are connected to the video display processor 421 via a bus.

<LC Control CPU 422a>

The LC control CPU 422a is provided to create a display list based on a command received from the performance control board 410, and transmit the display list to the video display processor (VDP) 421. In addition, the LC control CPU 422a performs control to display the image data stored in the CGROM 423 on the LC display device 41.

<LC Control ROM 422b>

The LC control ROM 422b includes a mask ROM and so forth and stores a program for control processing of the LC control CPU 422a, a display list generation program, animation patterns for displaying the animation of performance patterns, animation scene information and so forth. Here, the animation patterns are referred to display the animation of a performance pattern. The LC control ROM 422b stores combinations of pieces of animation scene information included in the performance pattern and also stores the display order of the pieces of animation scene information. In addition, the animation scene information may include a wait frame (display time), target data (the identification number of the sprite, the source address and so forth), parameters (the display position of the sprite, the destination address and so forth), a drawing method, information that designates a display device for displaying the performance image.

<LC Control RAM 422C>

The LC control RAM 422c is built in the LC control CPU 422a. The LC control RAM 422c functions as a work area for data when the LC control CPU 422a performs arithmetic processing, and is provided to temporarily store the data read from the LC control ROM 422b. Here, information to be stored in the LC control RAM 422c may include “performance time information” which is used to present a specific performance at a predetermined time.

<Frame Counter 422d>

The frame counter 422d is supplied with electric power from the power-supply board 500 to count a frame counter value. When the power-supply board 500 stops supplying electric power, the frame counter 422d stops counting the frame counter value. Then, when the power-supply board 500 resumes the supply of electric power, the frame counter 422d resets the frame counter value registered in the register and resumes counting.

<CGROM 423>

The CGROM (character generator read only memory) 423 is constituted by a flash memory, an EEPROM (electrically erasable programmable read only memory), an EPROM (erasable programmable read only memory), a mask ROM and so forth. The CGROM 423 compresses and stores image data (e.g. sprite data, movie data) constituted by a group of pixel information within a predetermined pixel range (e.g. 32×32 pixels). This pixel information is constituted by color number information designating the color number for each pixel and a value indicating the transparency of the image. In the CGROM 423, the video display processor 421 reads an image in units of image data, and image processing is performed in units of frame image data. Moreover, the CGROM 423 stores palette data in which the color number information designating the color number is associated with display color information for actually displaying the color in an uncompressed way.

Here, although with the present embodiment, the CGROM 423 stores the palette data in an uncompressed way, it is by no means limiting. Part of the pallet data may be compressed. In addition, to compress movies, various compression technologies, such as MPEG 4 are applicable.

<Crystal Oscillator 424>

The crystal oscillator 424 is provided to output a pulse signal (V-blank interrupt signal> to the video display processor 421 every “ 1/60 seconds (about 16.6 ms).” Also the video display processor 421 divides the frequency of the pulse signal to generate a system clock for the control and a synchronizing signal to synchronize with the LC display device 41. Then, upon detecting the V-blank interrupt signal, the video display processor 421 outputs a performance timing information signal to the LC control CPU 422a at a predetermined time, based on the V-blank interrupt signal.

<VRAM 425>

An SRAM (Static Random Access Memory) may be used as the VRAM 425. Here, the SRAM may be a readable and writable memory and a sort of volatile memory for temporarily storing data. Since the VRAM 425 includes a SRAM, it is possible to realize the high-speed processing to write and read image data. In addition, the VRAM 425 has a memory map constituted of an optional area, a display list area 1, a display list area 2, a frame buffer area 1 and a frame buffer area 2.

<RTC Device 426>

The RTC device 426 is provided to count a predetermined count value at an interval that is different from the interval of the frame counter 422d. The RTC device 426 is connected to the LC control CPU 422a in the image control board 420 via a bus. The RTC device 426 is provided to acquire the current date and time.

<General-Purpose Board 38>

The general-purpose board 38 is provided between the image control board 420 and the LC device 41, and has a bridge function to transform image data in a predetermined format and output it for display. The bridge function of the general-purpose board 38 also can transform image data in a format to support the performance of the LC display device 41 that displays the image data. For example, it is possible to absorb the difference in resolution between when a 19-inch SXGA (1280×1024) LC display device is connected and when a 17-inch XGA (1024×768) LC display device is connected.

<Sound Control Board 430>

The sound control board 430 is provided to control the sound output of the speakers 34 and 35 mainly for executing a performance. A sound source IC 431, a sound source ROM 432, an audio RAM 433 and an amplifier 434 are connected to the sound control board 430.

<Sound Source IC 431>

The sound source IC 431 is provided to read the program and data regarding the audio from the sound source ROM 432 and to generate an audio signal to drive the speakers 34 and 35.

<Sound Source ROM 432>

The sound source ROM 432 is provided to store a program and data for executing a performance. To be more specific, the sound source ROM 432 stores an audio program and audio data.

<Audio RAM 433>

The audio RAM 433 is provided to generate sound such as BGM, based on sound data corresponding to the performance.

<Amplifier 434>

The amplifier 434 is provided to amplify an audio signal from the sound source IC 431 and outputs the amplified signal to the speakers 34 and 35.

<Symbol Arrangement Table>

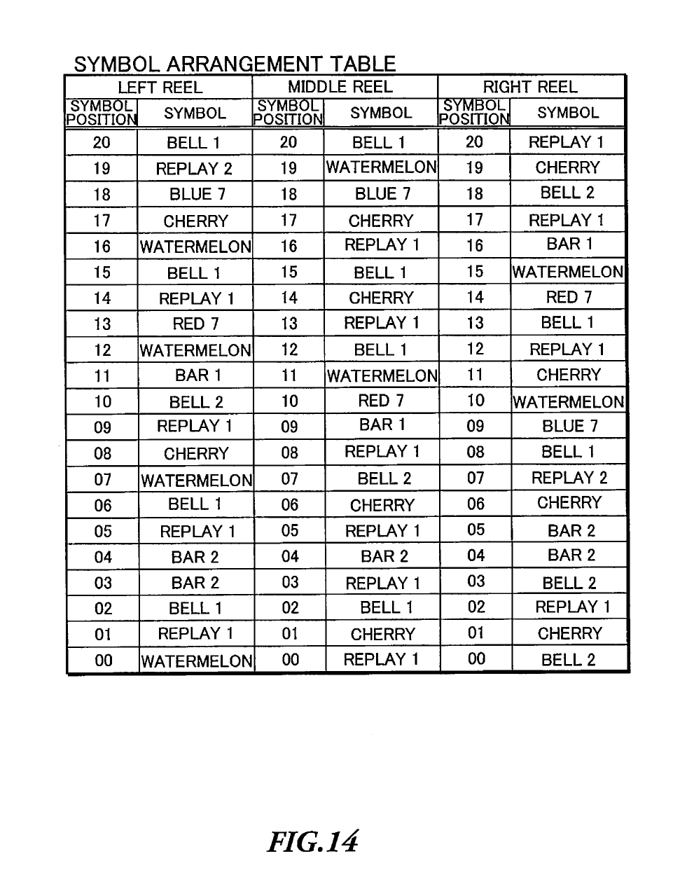

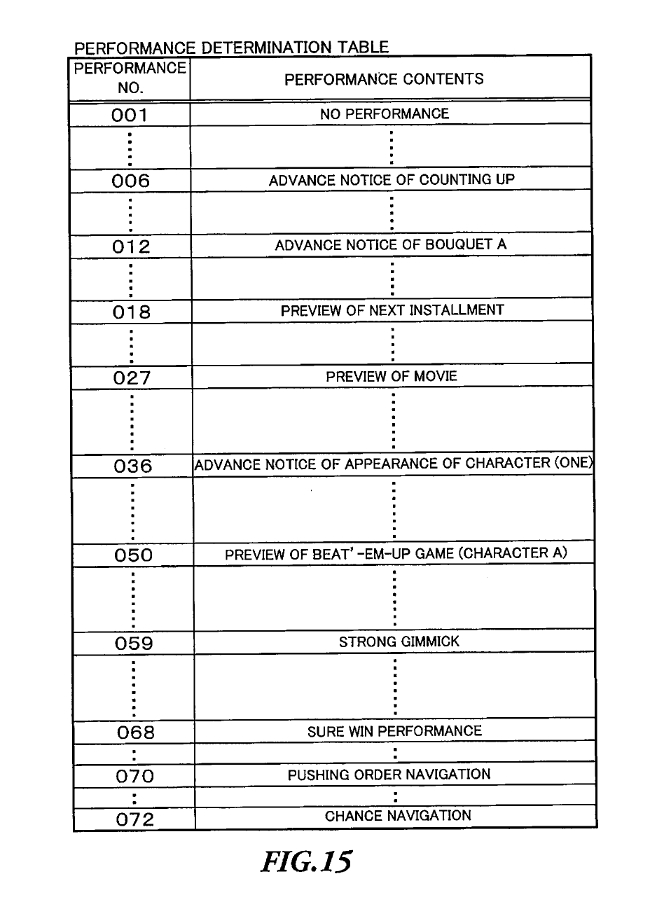

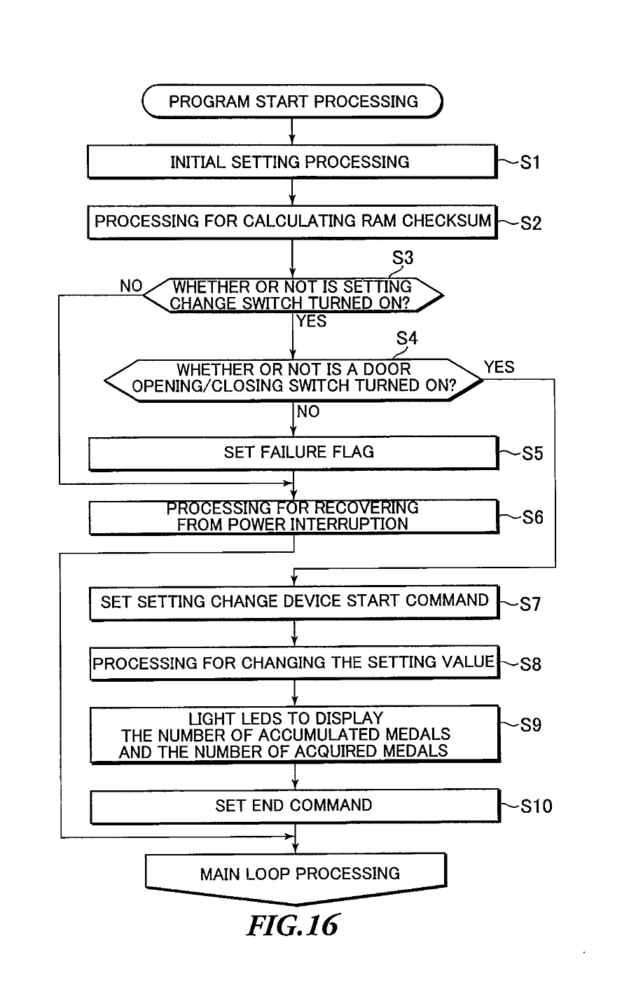

Next, a symbol arrangement table will be described with reference to FIG. 14.

The symbol arrangement table is provided in the main ROM 302. When the main CPU 301 detects the reel index, the position of the symbol displayed in the middle stage of the display window 21 is defined as “00” in the symbol arrangement table. “00” to “20” corresponding to the symbol counter are allocated to the symbols, respectively, in the order of the spinning direction of the reels, beginning from the symbol position “00”.

Symbols are allocated to the reels according to the symbol arrangement table shown in FIG. 14. When a predetermined combination of the symbols is arranged on the pay line, various prizes such as payout of medals, a replay and a bonus game, are provided to the player. For example, when bell 1, bell 1 and bell 1 are arranged on the pay line, nine medals are paid out; when replay 1, replay 1 and replay 1 are arranged on the pay line, a replay is activated; and when red 7, red 7 and red 7 are arranged on the pay line, a bonus game is activated.

<Performance Determination Table>

Next, the performance determination table will be described with reference to FIG. 15.

FIG. 15 shows the performance determination table provided in the sub-ROM 414. The sub-control board 400 determines various performances by using the performance determination table and controls the performances. To be more specific, the performance determination table defines “performance No.” and the performance contents corresponding to the performance numbers.

With the present embodiment, for example, “performance No. 068” corresponds to a win sure performance. This win sure performance is presented when it is determined that the game will progress to a bonus game.” When the win sure performance is executed, the lighting is controlled in the special lighting mode such that the LEDs 54A to 54G provided in the knob 50, the stop button performance lamp and the performance button lamp (not shown) are repeatedly lit, blinked and turned off. At this time, a sound (e.g. fanfare) is outputted from the speakers 34 and 35 to inform the player of that it is determined that the game will progress to a bonus game.

<Program Start Processing in the Main Control Board 300>

Next, program start processing in the main control board 300 will be described with reference to FIG. 16. Here, the program start processing is performed based on that the power-supply switch 511sw is turned on.

<Step S1>

In step S1, the main CPU 301 performs initial setting processing. To be more specific, the initial setting processing is performed to set the address of the table for setting the internal register of the game machine 1 and also set the address of the register, based on the table. Then, after the processing in the step S1 ends, the step moves to step S2.

<Step S2>

In the step S2, the main CPU 301 performs processing for calculating RAM checksum. To be more specific, the main CPU 301 performs the processing for calculating the checksum of the main RAM 303 and setting the calculated checksum of the main RAM 303. Here, the checksum is a kind of error detecting code. Then, after the processing in the step S2 ends, the step moves to step S3.

<Step S3>

In the step S3, the main CPU 301 performs processing for determining whether or not the setting change switch is turned on. With the present embodiment, the setting change switch is turned on by turning a setting change key inserted into the key hole (not shown) for a predetermined angle. Therefore, in the step S3, the main CPU 301 determines whether or not the setting change key (not shown) is turned for a predetermined angle while the setting change key is inserted into the key hole. Then, when it is determined that the setting change switch is turned on (step S3=Yes), the step moves to step S4. On the other hand, when it is determined that the setting change switch is turned off (step S3=No), the step moves to step S6.

<Step S4>

In the step S4, the main CPU 301 determines whether or not a door opening/closing switch is turned on. With the present embodiment, the dedicated key is inserted into the key hole 4 and turned for a predetermined angle, and the front door 3 opens for a predetermined angle or more, so that the door opening/closing switch is turned on. Therefore, in the step S4, the main CPU 301 performs processing for determining whether or not the dedicated key is inserted into the key hole 4 and turned for a predetermined angle, and the front door is open for a predetermined angle or more. Then, when it is determined that the door opening/closing switch is turned on (step S4=Yes), the step moves to step S7. On the other hand, when it is determined that the door opening/closing switch is turned off (step S4=No), the step moves to step S5.

<Step S5>

In the step S5, the main CPU 301 sets a failure flag. To be more specific, when the setting change switch is turned on (step S3=Yes) and the door opening/closing switch is turned off (step S4=No), the setting change key instated into the keyhole has been turned for a predetermined angle despite that the front door 3 is not open for a predetermined angle or more. In this case, the main CPU 301 sets the failure flag in a failure flag storage area provided in the main RAM 303. Then, after the processing in the step 5 ends, the step moves to the step S6.

<Step S6>

In the step S6, the main CPU 301 performs processing for recovering from power interruption. To be more specific, when the power supply to the game machine 1 is resumed after interrupting the power supply to the game machine 1, the main CPU 301 performs processing for recovering the saved register value and the saved stack pointer value. In addition, the processing for recovering from power interruption includes processing for initializing the main RAM 303. Then, after the processing in the step S6 ends, the processing moves to main loop processing shown in FIG. 17.

<Step S7>

In step S7, the main CPU 301 performs processing for setting a setting change device start command. To be more specific, when the setting change switch is turned on (step S3=Yes), and the door opening/closing switch is turned on (step S4=Yes), the main CPU 301 performs processing for setting the setting change device start command in a performance transmission data storage area in the main RAM 303, in order to transmit the setting change device start command to the sub-control board 400. Here, the setting change device start command has information indicating the start of the setting change of the game machine 1. Then, after the processing in the step S7 ends, the step moves to step S8.

<Step S8>

In the step S8, the main CPU 301 performs processing for changing the setting value. To be more specific, the main CPU 301 acquires the current setting value, and determines whether or not the range of the setting value is correct. Here, when it is determined that the range is correct, the main CPU 301 performs processing for displaying the current setting value on the accumulated medal number display 25 and the setting display part 36. On the other hand, when it is determined that the range is not correct, the main CPU 301 sets the default setting value in the setting value storage area provided in the main RAM 303, and then performs processing for displaying the default setting value on the accumulated medal number display 25 and the setting display part 36. Then, the main CPU 301 performs processing for changing and displaying the setting value, based on that the setting change switch 37sw detects the setting change button 37 being operated; processing for fixing the setting value, based on the start switch 10sw detects the start lever 10 being operated; and processing for storing the setting value in the setting value storage area in the main RAM 303, based on that it is detected that the setting change key having been turned for a predetermined angle is being turned to the angle to allow the key to be taken out. Then, after the processing in the step S8 ends, the step moves to step S9.

<Step S9>

In the step S9, the main CPU 301 performs processing for lighting LEDs to display the number of accumulated medals and the number of acquired medals. To be more specific, the main CPU 301 commands to the accumulated medal number display 25 and the payout number display 27 to display the number of the accumulated medals and the number of the medals to be paid out. Here, the accumulated medal number display 25 and the payout number display 27 are connected to the relay board 200 via the I/F circuit 305. Then, after the processing in the step S9 ends, the step moves to step S10.

<Step S10>

In the step S10, the main CPU 301 performs processing for setting an end command to end the setting change device. To be more specific, the main CPU 301 performs the processing for setting the end command in the performance transmission data storage area in the main RAM 303, in order to transmit the end command to the sub-control board 400. Here, this end command to end the setting change device has information indicating that the setting value has been changed and information regarding the changed setting value. Then, after the processing in the step S10 ends, the processing moves to the main loop processing shown in FIG. 17.

<Main Loop Process>

Next, main loop processing will be described with reference to FIG. 17.

<Step S101>

In step S101, the main CPU 301 performs initialization processing. To be more specific, the main CPU 301 performs the processing for setting a stack pointer and initializing the main RAM 303. Then, when the processing in the step S101 ends, the step moves to step S102.

<Step S102>

In the step S102, the main CPU 301 performs game start control processing. To be more specific, the main CPU performs the processing for clearing the number of medals to be paid out and setting the current game state. Then, when the processing in the step S102 ends, the step moves to step S103.

<Step S103>

In the step S103, the main CPU 301 performs overflow display processing. To be more specific, the main CPU 301 performs the processing for predetermined error display by the payout number display 27 via the relay board 200, based on that the auxiliary fill-up sensor 530s detects the auxiliary accumulation part 530 being filled up with the medals. Then, when the processing in the step S103 ends, the step moves to step S104.

Here, with the present embodiment, the predetermined error display is performed by the payout number display 27. However, it is by no means limiting, but another display device or lamp may be used. For example, information may be provided by a plurality of devices such as the payout number display 27, the LC display device 41 and so forth.

<Step S104>

In the step S104, the main CPU 301 performs processing for starting accepting a medal. During the processing, the main CPU 301 performs processing for allowing a medal to be accepted when a replay is not activated. Then, when the processing in the step 104 ends, the step moves to step S105. Here, the processing for starting accepting a medal may include, for example, processing for adding the inserted medal number counter by insertion of an additional medal, and setting an automatic insertion command at the time of a replay.

<Step S105>

In the step S105, the main CPU 301 performs processing for checking the setting value. To be more specific, the main CPU 301 performs the processing for reading the setting value that was stored in the setting value storage area in the main RAM 303 in the step S10. Then, when the processing in the step S105 ends, the step moves to step S106.

<Step S106>

In the step S106, the main CPU 301 performs medal management processing. During this process, the main CPU 301 performs processing for checking if a medal is inserted. Then, when the processing in the step S106 ends, the step moves to step S107. Here, this medal management processing includes, for example, processing for checking if a correct medal is inserted into the medal insertion slot 6 and processing for adjust the medals at the medal adjustment time.

<Step S107>

In the step S107, the main CPU 301 performs processing for checking insertion/payout sensors. In this processing, the main CPU 301 performs processing for displaying a failure when the medal sensor 16s or a payout sensor (not shown) provided in the hopper 520 detects the failure. Then, when the processing in the step 107 ends, the step moves to step S108. Here, this processing for checking the insertion/payout sensors may include processing for determining whether or not the medal sensor 16s detects a failure, and processing for determining whether or not the payout sensor (not shown) provided in the hopper 520 detects a failure.

<Step S108>

In the step S108, the main CPU 301 performs processing for checking the start lever. This processing may include, for example, processing for determining whether or not the start switch 10sw is turned on. Then, when the processing in the step S108 ends, the step moves to step S109. Here, this processing for checking the start lever may include processing for determining whether or not the operation of the start lever 10 is acceptable. When it is determined that the operation of the start lever 10 is acceptable, the operation of the start lever 10 is allowed to be accepted.

<Step S109>

In the step S109, the main CPU 301 performs internal lottery processing. This processing includes the processing for determining whether or not a bonus, a small win, or a replay can be acquired through a lottery. Then, when the processing in the step 109 ends, the step moves to step S110. Here, this internal lottery processing may include acquiring data such as the current game state, the number of lotteries in the current game and the kind of RT.

<Step S110>

In step S110, the main CPU 301 performs symbol code setting processing. This processing includes processing for holding a lottery to determine whether or not to perform a reel spin performance, based on the win area determined in the step S109. Then, when the processing in the step S110 ends, the step moves to step S111.

<Step S111>

In the step S111, the main CPU 301 performs processing for preparing to start to spin the reels. This processing includes processing for setting the time for at least one game. Then, when the processing in the step S111 ends, the step moves to step S112. Here, this processing also includes processing for determining whether or not the value of the timer counter set in the previous game has become “0”. Here, the timer counter value may be set to the time for at least one game (about 4.1 seconds). In addition, the processing for preparing to start to spin the reels may include processing for setting the waiting time until the spin speed of the reels 17 is constant.

<Step S112>

In step S112, the main CPU 301 performs pre-processing for stopping the reels. This processing includes processing for shifting the symbol stop position during which the reels 17 are spinning. Then, when the processing in the step S112 ends, the step moves to step S113. Here, this processing for shifting the symbol stop position includes processing for setting the initial value of a virtual stop position to acquire the priorities of the symbols; and processing for correcting the stop position when the stop position is not “00”, and saving the priorities.

<Step S113>

In the step S113, the main CPU 301 performs processing for starting to spin the reels 17. To be more specific, the main CPU 301 performs the processing for spinning the reels 17 at a constant speed by driving the stepping motors 101, 102 and 103 via the reel control board 100. Then, when the processing in the step S113 ends, the step moves to step S114.

<Step S114>

In the step S114, the main CPU 301 performs processing for setting an operable state flag. To be more specific, the main CPU 301 performs the processing for turning on operable state flags in operable state flag storage areas provided in the main RAM 303. Here, the operable state flag areas are provided corresponding to the stop buttons 11, 12 and 13, respectively. In addition, the operable state flags are used to determine whether or not the stop buttons 11, 12 and 13 can perform stop operation. For example, when all the operable state flags respectively corresponding to the stop buttons 11, 12 and 13 are turned off, the main CPU 301 determines that all the stop buttons 11, 12 and 13 can perform stop operation. Then, when the processing in the step S114 ends, the step moves to step S115.

<Step S115>

In the step S115, the main CPU 301 performs processing for which the reels 17 are spinning. This processing includes processing for controlling to stop the spin of the corresponding reel 17, based on that the stop switch 11sw, 12sw and 13sw detects the player operating the stop button 11, 12 and 13. Then, when the processing in the step S115 ends, the step moves to step S116.

<Step S116>

In the step S116, the main CPU 301 performs processing for determining whether or not there is a stop request. To be more specific, the main CPU 301 performs the processing for determining whether or not the stop switches 11sw, 12sw and 13sw detected the player operating the stop buttons 11, 12 and 13, so that the spinning reels 17s were stopped in the step 115. Then, when it is determined that there is no stop request (step S116=No), the step moves to step S118. On the other hand, it is determined that there is a stop request (step S116=Yes), the step moves to step S117.

<Step S117>

In the step S117, the main CPU 301 performs processing for setting a reel stop command. To be more specific, the main CPU 301 performs the processing for setting a reel stop command in the performance transmission data storage area in the main RAM 303, in order to transmit the reel stop command to the sub-control board 400. Here, the reel stop command includes information on the kind of the stopped reel 17; information on the symbol position at the time the stop switches 11sw, 12sw and 13sw detect the player operating the stop buttons 11, 12 and 13; and information on the symbol code corresponding to the symbol position. Then, when the processing in the step S117 ends, the step moves to step S118.

<Step S118>

In the step S118, the main CPU 301 performs processing for determining whether or not all the reels 17 have stopped. To be more specific, the main CPU 301 performs the processing for determining whether or not all the reels 17 have stopped, based on the value of the operable state flag storage area provided in the main RAM 303. Then, when it is determined that part of the reels 17 has not stopped yet (step S118=No), the step moves to the step S114, and the processing is repeatedly performed until all the reels 17 have stopped. On the other hand, when it is determined that all the reels 17 have stopped (step S118=Yes), the step moves to step S119.

<Step S119>

In the step S119, the main CPU 301 determines whether or not the stop buttons 11, 12 and 13 are being operated. To be more specific, the main CPU 301 performs the processing for determining whether or not the stop switches 11sw, 12sw and 13sw have been turned off. Then, when it is determined that the stop buttons 11, 12 and 13 are being operated (step S119=Yes), the processing in the step S119 is repeatedly performed until the stop buttons 11, 12 and 13 have not been operated. On the other hand, when it is determined that the stop buttons 11, 12 and 13 are not being operated (step S119=No), the step moves to step S120.

<Step S120>

In the step S120, the main CPU 301 performs display determination processing. This processing includes processing for calculating the number of medals to be paid out, according to the combination of the symbols for the win. Then, the processing in the step S120 ends, the step moves to step S121.

Here, this processing may include processing for setting a replay activation command at the time of the display of the replay, processing for calculating the number of medals to be paid out, and processing for determining a failure of the display determination.

<Step S121>

In the step S121, the main CPU 301 performs processing for checking the insertion/payout sensors. In this processing, when the medal sensor 16s or a payout sensor (not shown) provided in the hopper 520 detects a failure, the main CPU 310 performs processing for displaying the detected failure, in the same way as in the step S107. Then, when the processing in the step 121 ends, the step moves to step S122.

<Step S122>

In the step S122, the main CPU 301 performs payout processing. This processing includes processing for paying out the medals by driving the hopper 520 via the power-supply board 500. Then, when the processing in the step S122 ends, the step moves to step S123.

Here, this payout processing may include processing for determining whether or not the value of an accumulated medal number counter is “50”. Here, when the value is smaller than “50”, medals are added, and, on the other hand, when the number of the medal accumulation is greater than “50” during the addition, the medals for greater than “50” are paid out.

<Step S123>

In the step S123, the main CPU 301 performs processing for moving the game state. This processing includes processing for moving the RT game state, based on the combination of the symbols arranged on the pay line. Then, when the processing in the step S123 ends, the step moves to the step S101, and subsequent processing is repeatedly performed.

<Interrupt Processing>

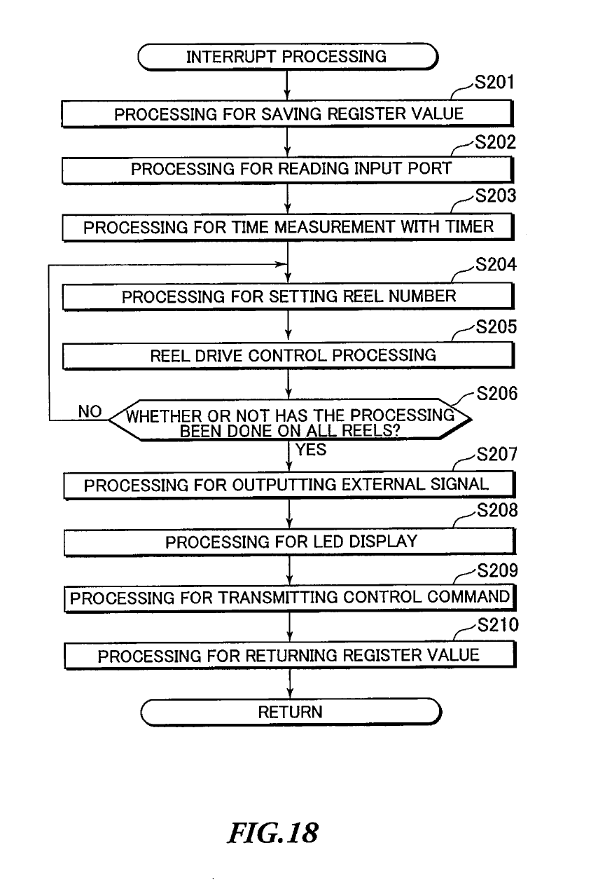

Next, interrupt processing will be described with reference to FIG. 18. Here, “interrupt processing” is performed to interrupt the main loop processing every 1.49 ms. Here, FIG. 18 shows a sub-routine of the interrupt processing.

<Step S201>

In step S201, the main CPU 301 performs processing for saving the register value. To be more specific, the main CPU 301 performs the processing for saving the register value at the time of the step S201. Then, when the processing in the step S201 ends, the step moves to step S202.

<Step S202>

In the step S202, the main CPU 301 performs processing for reading the input port. To be more specific, the main CPU 301 performs the processing to receive signals from the reel control board 100, the relay board 200, and the power-supply board 500 via the I/F circuit 305. Then, when the processing in the step S202 ends, the step moves to step S203.

<Step S203>

In the step S203, the main CPU 301 performs processing for time measurement with the timer. To be more specific, the main CPU 301 performs the processing for subtracting “one” from the value of the timer counter used to measure the spin time for the reel spin performance and the time for at least one game. Then, when the processing in the step S203 ends, the step moves to step S204.

<Step S204>

In the step S204, the main CPU 301 performs processing for setting the reel number. To be more specific, the main CPU 301 performs the processing for setting the reel number in order to set the reel targeted for reel drive control processing in step S205 described later. Then, when the processing in the step S204 ends, the step moves to step S205.

<Step S205>

In the step S205, the main CPU 301 performs reel drive control processing. To be more specific, the main CPU 301 drives the stepping motor of the reel corresponding to the reel number set by the processing in the step S204, via the reel control board 100 to control the speed of the reel 17, that is, to perform acceleration control, constant-speed control and deacceleration control. In addition, the main CPU 301 performs processing for controlling the reels 17 to spin in the opposite direction during the reel spin performance. Then, when the processing in the step S205 ends, the step moves to step S206.

<Step S206>

In the step S206, the main CPU 301 performs processing for determining whether or not the processing has been done on all the reels. To be more specific, the main CPU 301 performs the processing for determining whether or not the reel drive control processing in the step S205 has been done on all the reels 17. Then, when it is determined that the processing has been done on all the reels (step 206=Yes), the step moves to step S207. On the other hand, it is determined that the processing has not been done on part of the reels (step S206=No), the step moves to the step S204, and the same processing is repeatedly performed until the processing has been done on all the reels.

<Step S207>

In step S207, the main CPU 301 performs processing for outputting an external signal. This processing may include the processing for outputting data indicating the game state to a terminal board (not shown). Then, when the processing in the step 207 ends, the step moves to step S208.

<Step S208>

In the step S208, the main CPU 301 performs processing for LED display. To be more specific, the main CPU 301 performs the processing for controlling the lighting of the start lamp 23, the bet lamps 24a to 24c, the accumulated medal number display 25, the game state display lamp 26, the payout number display 27, the insertion possible display lamp 28, and the replay display lamp 29. Then, when the processing in the step S208 ends, the step moves to step S209.

<Step S209>

In the step S209, the main CPU 301 performs processing for transmitting a control command. To be more specific, the main CPU 301 performs the processing for transmitting various commands set in the performance transmission data storage area provided in the main RAM 303, to the sub-control board 400. Then, when the processing in the step S209 ends, the step moves to step S210.

<Step S210>

In the step S210, the main CPU 301 performs processing for returning the register value. To be more specific, the main CPU 301 performs the processing for returning the saved register value. Then, when the processing in the step S210 ends, the main CPU 301 terminates the interrupt processing and returns to the main loop processing.

<Main Processing in the Sub-Control Board>

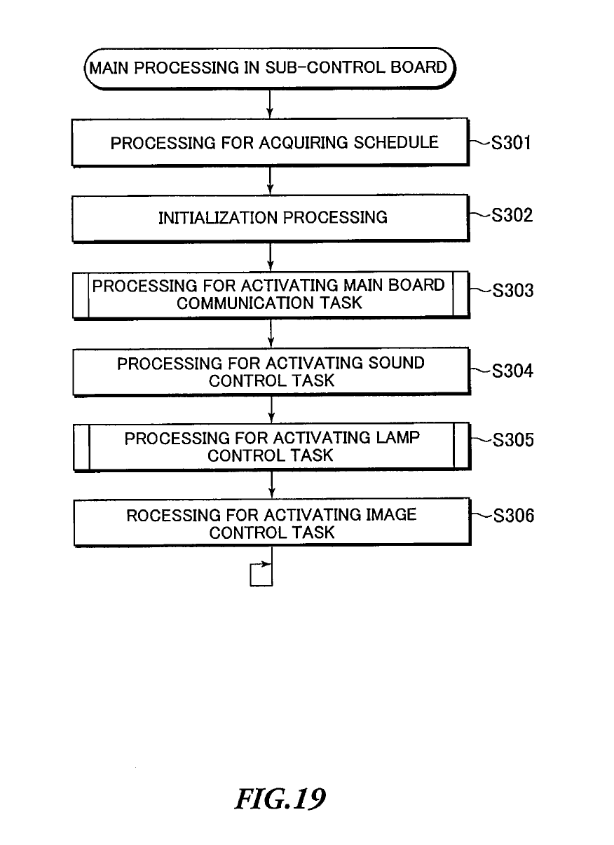

Next, the main processing in the sub-control board will be described with reference to FIG. 19. Here, the main processing in the sub-control board is performed based on that the power-supply switch 511sw is turned on.

<Step S301>

In step S301, the sub-CPU 421 performs processing for acquiring the schedule. This processing may include the processing for loading date information acquired by the RTC device 426. The processing for loading day-of-the-week information corresponding to the date may be performed at the same time. Then, the sub-CPU 412 determines whether or not the current date is a specific day, based on the loaded date information and so forth. When it is determined that the current date is the specific day, the sub-CPU 412 performs processing for acquiring the schedule corresponding to the date information. When the processing in the step S310 ends, the sub-CPU 412 moves the step to step S302.

<Step S302>

In the step S302, the sub-CPU 412 performs initialization processing. To be more specific, the sub-CPU 412 performs the processing for checking an error of the sub-RAM 415 and for initializing the task system. Then, when the processing in the step S302 ends, the step moves to step S303.

<Step S303>

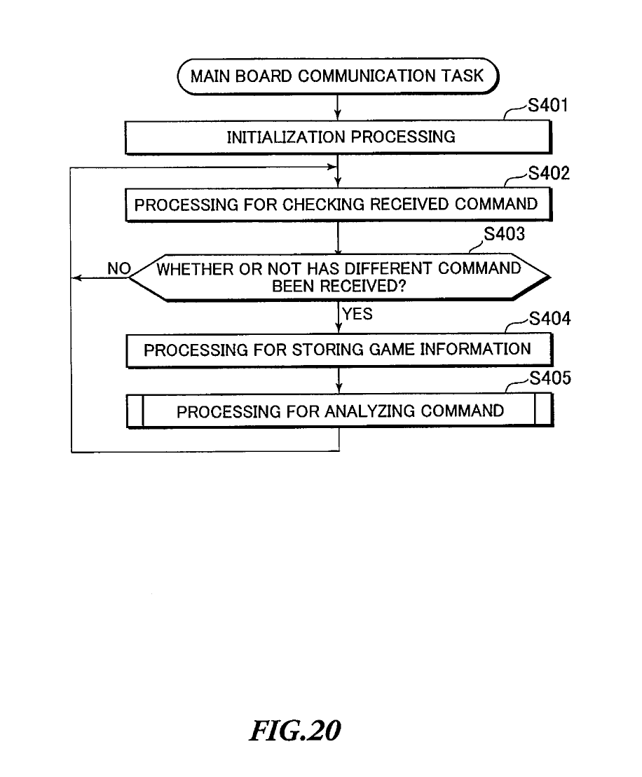

In the step S303, the sub-CPU 412 performs processing for activating a main board communication task. To be more specific, the sub-CPU 412 performs the processing for activating the main board communication task in order to perform the processing shown in FIG. 20. Then, when the processing in the step S303, the step moves to step S304.

<Step S304>

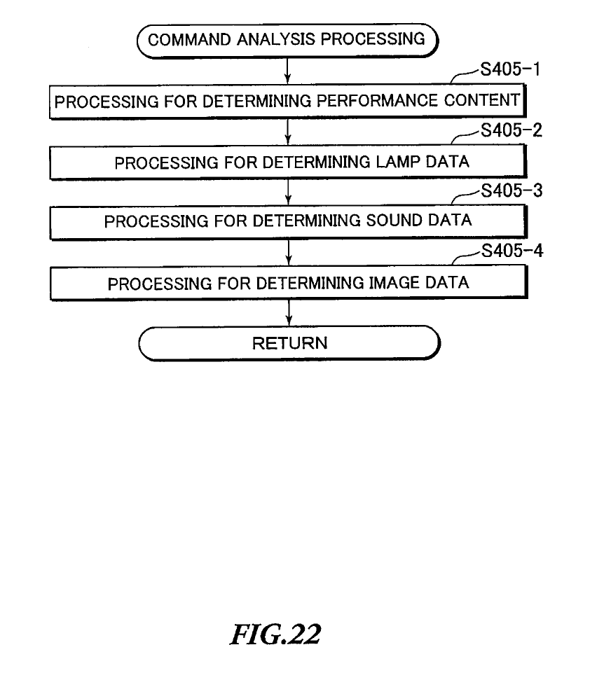

In the step S304, the sub-CPU 412 performs processing for activating a sound control task. Here, during this sound control task, the sub-CPU 412 performs processing for analyzing the sound data determined in the processing for determining sound data in step S405-3 described later (see FIG. 22), and controlling the sound outputted from the speakers 34 and 35, based on the result of the analysis. Then, when the processing in the step S304, the step moves to step S305.

<Step S305>

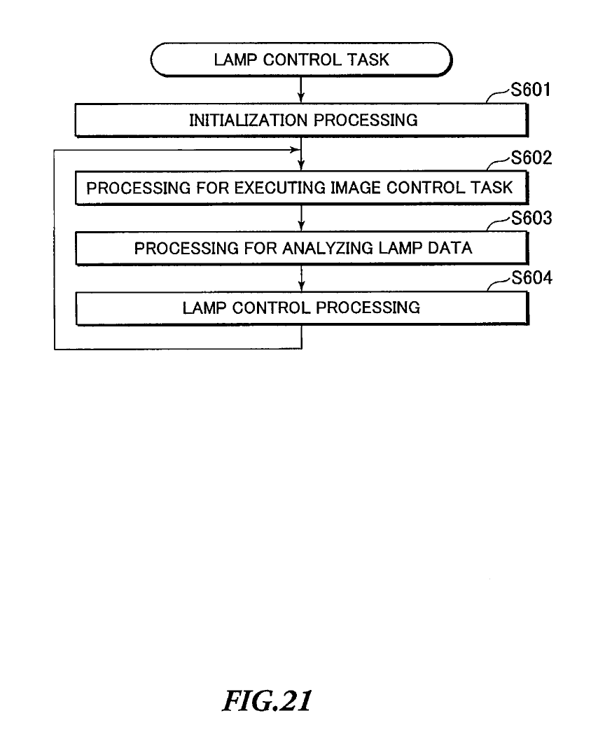

In the step S305, the sub-CPU 412 performs processing for activating a lamp control task. To be more specific, the sub-CPU 412 performs the processing for activating the lamp control task in order to perform the processing shown in FIG. 21. Then, when the processing in the step S305 ends, the step moves to step S306.

<Step S306>

In the step S306, the sub-CPU 412 performs processing for activating an image control task. Here, during this image control task, the sub-CPU 412 performs processing for analyzing the image data determined in the processing for determining image data in step S405-4 described later (see FIG. 22), and outputting a signal to the image control board 420, based on the result of the analysis. Then, when the processing in the step S306 ends, the main processing in the sub-control board is terminated.

<Main Board Communication Task>

Next, the main board communication task will be described with reference to FIG. 20.

<Step S401>

In step S401, the sub-CPU 412 performs initialization processing. To be more specific, the sub-CPU 412 performs processing for initializing a predetermined storage area in the sub-RAM 415. Then, when the processing in the step S401 ends, the step moves to step S402.

<Step S402>

In the step S402, the sub-CPU 412 performs processing for checking a received command. To be more specific, the sub-CPU 412 performs the processing for checking the command transmitted form the I/F circuit 305 in the main control board 300 to the I/F circuit 411. Then, when the processing in the step S402 ends, the step moves to step S403.

<Step S403>

In the step S403, the sub-CPU 412 performs processing for determining whether or not a different command has been received. To be more specific, the sub-CPU 412 performs the processing for determining whether or not the command transmitted from the I/F circuit 305 in the main control board 300 is different from the command previously transmitted. Then, when it is determined that the received command is different from the previous one (step S403=Yes), the step moves to step S404. On the other hand, when it is determined that a different command has not been received (step S403=No), the step moves to the step S402.

<Step S404>

In the step S404, the sub-CPU 412 performs processing for storing game information. To be more specific, the sub-CPU 412 performs processing for generating game information based on the command checked by the processing in the step S402 and storing the information in the sub-RAM 415. By this processing, the information contained in the parameter of the command inputted from the I/F circuit 305 in the main control board 300 to the I/F circuit 411 is stored in the sub-RAM 415. Therefore, the sub-control board 400 can control the information that is controlled also in the main control board 300. Then, when the processing in the step S404 ends, the step moves to step S405.

<Step S405>

In the step S405, the sub-CPU 412 performs command analysis processing, which will be described later with reference to FIG. 22. This processing includes the processing corresponding to the command inputted from the I/F circuit 305 in the main control board 300 to the I/F circuit 411. Then, when the processing in the step S405, the step moves to the step S402.

<Lamp Control Task>

Next, the lamp control task will be described with reference to FIG. 21.

<Step S601>

In step S601, the sub-CPU 412 performs initialization processing. To be more specific, the sub-CPU 412 performs the processing for initializing data on the lamps. Then, when the processing in the step S601 ends, the step moves to step S602.

<Step S602>

In the step S602, the sub-CPU 412 performs processing for executing the image control task. This processing includes the processing for analyzing the image data determined in the processing for determining image data in step S405-4 described later (see FIG. 22), and outputting a predetermined signal to the image control board 420, based on the result of the analysis. Then, when the processing in the step S602 ends, the step moves to step S603.

<Step S603>

In the step S603, the sub-CPU 412 performs processing for analyzing lamp data. This processing includes processing for analyzing the lamp data determined in the lamp data determination processing of step S405-2 described later (see FIG. 22). Then, when the processing in the step S603 ends, the step moves to step S604.

<Step S604>

In the step S604, the sub-CPU 412 performs lamp control processing. To be more specific, the sub-CPU 412 performs the processing for controlling the lighting of the side lamp 5, the performance lamp 22, the stop operation order display lamp 30, and the LEDs 54A to 54G provided in the knob 50, based on the result of the analysis of the processing in the step S603. Then, when the processing in the step S604 ends, the step moves to step S602.

<Processing for Analyzing a Command>

Next, processing for analyzing a command will be described with reference to FIG. 22. Here, FIG. 22 shows a sub-routine of command analysis processing.

<Step S405-1>

In step S405-1, the sub-CPU 412 performs processing for determining performance contents. This processing includes processing for determining various performance contents, based on the received command. Then, when the processing in the step S405-1 ends, the step moves to the step S405-2.

<Step S405-2>

In the step S405-2, the sub-CPU 412 performs processing for determining lamp data. To be more specific, the sub-CPU 412 performs the processing for determining the lamp data corresponding to the performance content determined by the processing in the step S405-1. Then, when the processing in the step S405-2 ends, the step moves to the step S405-3.

For example, when the performance is determined, which is presented at the time No. 068 of the win sure performance (see the performance determination table shown in FIG. 15) is determined, the sub-CPU 412 controls the lighting in the special lighting mode such that the LEDs 54A to 54G provided in the knob 50, the stop button performance lamp and the performance button lamp (not shown) are repeatedly lit, blinked and turned off. Here, the special lighting mode is not limited to this. A plurality of lighting modes (patterns) are possible, or any of the plurality of lighting patterns may be selected, for example, through a lottery or randomly.

<Step S405-3>

In the step S405-3, the sub-CPU 412 performs processing for determining sound data. To be more specific, the sub-CPU 412 performs the processing for determining the sound data corresponding to the performance content determined by the processing in the step S405-1. Then, when the processing in the step S405-3 ends, the step moves to step S405-4.

<Step S405-4>

In the step S405-4, the sub-CPU 412 performs processing for determining image data. To be more specific, the sub-CPU 412 performs the processing for determining the image data corresponding to the performance content determined by the processing in the step S405-1. Then, when the processing in the step S405-4 ends, the command analysis processing is terminated, and the step moves to the step S402 in the main board communication task (see FIG. 20).

Here, with the present embodiment, the start lever 10 is used as an example of the operation device that can be operated by the player. However, it is by no means limiting, but the present invention is applicable another operation device such as a stop switch and so forth. In addition, with the present embodiment, it has been described that the present invention is applied to a slot machine. However, it is by no means limiting, but the present invention is applicable to a pachinko game machine, a mahjong ball game machine, and an arrange ball game machine as long as the game machine can be operated by the player.

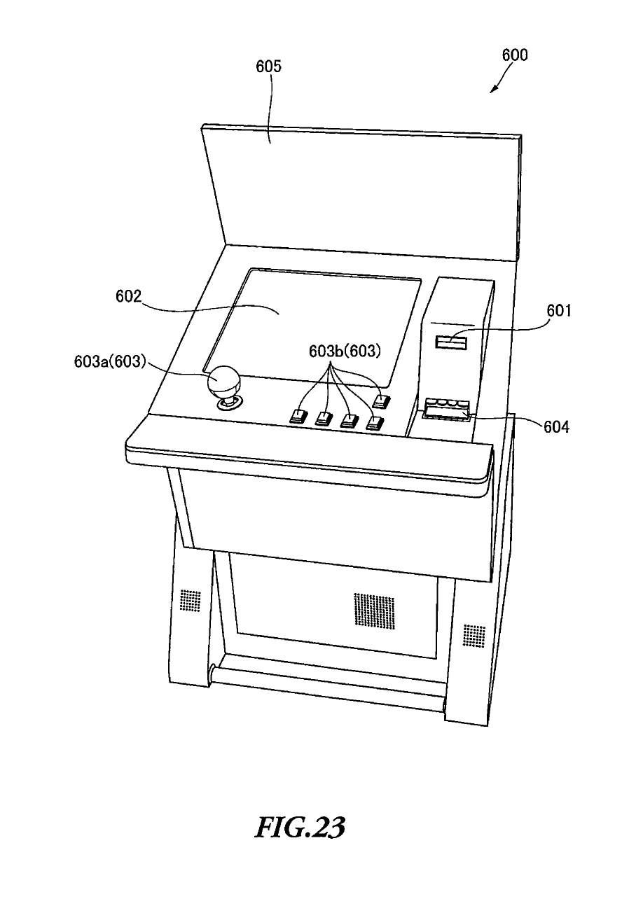

For example, “operation device” as described above may be applicable to video game. Here, a video game device 600 having the operation device according to the present invention will be described with reference to FIG. 23.

As shown in FIG. 23, the video game device 600 can perform a card game (e.g. poker, and baccarat), and a slot machine game. This video game device 600 includes an insertion slot 601 into which a card or paper money can be inserted; a first image display device 602 that can display game images of a card game, a slot machine game and so forth; operation devices 603 that can start and stop the game, and select various images; a payout slot 604 from which a prize such as a card or paper money can be paid out; and a second image display device 605 that can display performance images associated with the game.

The operation device 603 includes an operation lever 603a that can swing and has a knob, and a plurality of operation buttons 603 that can be pushed.

In the video game device 600 with the above-described configuration, the operation device 603 is enabled by inserting a card or paper money into the insertion slot 601, and can be used to perform a video game such as a card game, a slot machine game and so forth, in the same way as in the above-described game machine 1.

Here, the flow of a video game performed by the video game device 600 will be described in two cases: when the video game is a card game; and when the video game is a slot machine game.

First, one case in which the video game is a card game (e.g. poker game) will be described. The video game device 600 is configured to perform a card game by the player. The card game can be performed by inserting a card and so forth into the insertion slot 601, and then operating the operation lever 603a.

To be more specific, when the operation lever 603a is operated, the first image display device 602 displays a plurality of rear surface images that imitate the rear surfaces of playing cards, and then, when any of the operation devices 603 is operated, the rear surface image corresponding to the operation button 603b is inverted and a face card image representing a picture is displayed. Then, in a case in which the plurality of face card images constitute a specific condition (e.g. one pair), a prize corresponding to this specific condition is paid out from the payout slot 604.

Next, the other case in which the game performed by the video game device 600 is a slot machine game will be described. The video game device 600 is configured to perform a slot machine game by the player. The slot machine game can be performed by inserting a card and so forth into the insertion slot 601, and then operating the operation lever 603a, in the same way as in the case of a card game.

To be more specific, when the player operates the operation lever 603a, the plurality of still reel images on the first image display device 602 spin at a time, and, when the player operates the operation devices 603b, the reel images corresponding to the operation button 603b can be stopped. Then, when the combination of the stopped symbols represents a specific condition, a prize corresponding to the specific condition is paid out from the payout slot 604.

In the video game device 600 with the above-described configuration, a plurality of LEDs can be built in the knob of the operation lever 603a or the operation button 603b, like the above-described start lever 10.

In this case, when a predetermined condition is met, for example, when it is previously determined that a card game or a slot game is provided with a specific condition, it is possible to light and blink a plurality of LEDs. As a result, it is possible to prevent the player from getting bored with the game because of little variation in the lighting mode of the operation device, in the same way as in the game machine 1.

Although the preferred embodiment has been explained, it is by no means limiting, it will be appreciated that various modifications and alterations are possible without departing from the scope of the invention.

1. A game machine comprising an operation device configured to be operated by a player,
an operation device including:
a translucent operation part;
a light source board on which a light source is arranged to light up the operation part from an inside of the operation part, the light source board being provided in the operation part;
a detection part configured to detect an operation being accepted by the operation part; and
a transmission part configured to inform he detection part of that the operation has been accepted.

2. The game machine according to claim 1, wherein the operation part includes:
a rear body configured to face the transmission part; and
a front body configured not to face the transmission part, the rear body and the front body being coupled to one another while sandwiching the light source board therebetween.

3. The game machine according to claim 2, wherein the front body is removable coupled to the rear body.

4. The game machine according to claim 1, wherein a plurality of light sources are arranged on the light source board.

5. The game machine according to claim 2, wherein a translucent lens member including a multi-faced lens is provided between the front body and the light source board.

6. The game machine according to claim 2, wherein the transmission part is formed of a rod.
